(19) United States
(12) Patent Application Publication
(10) Pub. No.: US 2018/0027569 A1
(43) Pub. Date: Jan. 25, 2018

(54) BASE STATION SYSTEM AND RADIO APPARATUS

(71) Applicant: FUJITSU LIMITED, Kawasaki-shi (JP)

(72) Inventors: Haiqing DU, Yokohama (JP); Yutaka ISONUMA, Yokohama (JP)

(73) Assignee: FUJITSU LIMITED, Kawasaki-shi (JP)

(21) Appl. No.: 15/618,537

(22) Filed: Jun. 9, 2017

(30) Foreign Application Priority Data
Jul. 22, 2016 (JP) 2016-144972

(51) Int. Cl. H04W 72/04; H04W 24/08

(52) U.S. Cl. CPC H04W 72/0486; H04W 72/0453; H04W 24/08

(57) ABSTRACT

A base station system includes a controller and a plurality of radio apparatuses, each of the radio apparatus being multistage-connected to each other and being configured to communicate with the controller, wherein a transmission frame between the radio apparatuses and the controller includes a plurality of blocks, wherein one or several blocks are allocated to a shared area for a data signal that is shared among two or more of the radio apparatuses, and other blocks are allocated to an individual area for a data signal that is not shared among two or more of the radio apparatuses, wherein each of the radio apparatuses is configured to select whether the block that is used for a radio area which is provided by the own radio apparatus is set to be a block that is allocated to the shared area, or a block that is allocated to the individual area.

### CROSS-REFERENCE TO RELATED APPLICATION

This application is based upon and claims the benefit of priority of the prior Japanese Patent Application No. 2016-144972, filed on Jul. 22, 2016, the entire contents of which are incorporated herein by reference.

### FIELD

The embodiments discussed herein are related to a base station system, a radio apparatus for autonomously determining whether or not a radio area that is provided by an own radio apparatus may be set to be a shared area which is shared with another radio apparatus, according to a traffic situation of the own radio apparatus.

### BACKGROUND

At present, in a configuration of a base station system that provides a radio service, a separation-type base station is mainly used in which a base band unit that processes a base band signal and a remote radio head that transmits or receives a radio wave from an antenna are separated. As an interface between the base band unit and the remote radio head, for example, an all-purpose interface in compliance with a common public radio interface (CPRI) specification or the like is defined. In the CPRI specification, the base band unit is also referred to as a radio equipment controller (REC), and the remote radio head is also referred to as radio equipment (RE). Furthermore, in the CPRI specification, user data (which is also referred to as U-plane data, a digital base band signal, or a data signal) that is transmitted between the radio equipment controller and the radio equipment is also referred to as in-phase and quadrature (IQ) data.

In the related art, technologies have been proposed that manages a connection relationship through the CPRI interface between the radio equipment controller and the radio equipment that constitute the base station system, in a concentrated manner with a higher level node of the base station system, and dynamically updates the connection relationship between the radio equipment controller and the radio equipment according to a traffic situation, a malfunction of a device, or the like.

Examples of the related art include Japanese Laid-open Patent Publication No. 2012-134708, Japanese Laid-open Patent Publication No. 2014-121054, Japanese National Publication of International Patent Application No. 2012-519413, and Non-Patent Literature [Common Public Radio Interface (CPRI), “CPRI Specification V7.0 (2015-10-09)”, http://www.cpri.info/downloads/CPRI_v_7_0_2015-10-09.pdf].

### SUMMARY

According to an aspect of the invention, a base station system includes: a link structure in which a plurality of radio apparatuses are multistage-connected to each other and are configured to communicate with a radio equipment controller. In the base station system, a downlink transmission frame and an uplink transmission frame between the radio apparatuses and the radio equipment controller include a plurality of blocks, in each of which a data signal is stored, wherein one or several blocks among the plurality of blocks are allocated to a shared area for a data signal that is shared among two or more of the radio apparatuses, and other blocks are allocated to an individual area for a data signal that is not shared among two or more of the radio apparatuses.

In the base station system according to an aspect of the invention, each of the radio apparatuses is configured to execute a transferring process that includes transferring a measurement value relating to a traffic situation of an own radio apparatus, the measurement value being stored in at least one of the downlink transmision frame that is transferred from a front stage radio apparatus to a rear stage radio apparatus and the uplink transmision frame that is transferred from the rear stage radio apparatus to the front stage radio apparatus in the link structure, the front stage radio appratus being one of the radio apparatuses and being located at start of the link structure, the rear stage radio apparatus being one of the radio apparatuses and being located at end of the link structure, execute a collecting process that includes collecting a measurement value relating to a traffic situation of each of other radio apparatuses using at least one of the uplink transmission frame and the downlink transmission frame, and execute a selecting process that includes selecting whether the block that is used for a radio area which is provided by the own radio equipment is set to be a block that is allocated to the shared area, or a block that is allocated to the individual area, based on the collected measurement value relating to the traffic situation of each of the other radio apparatuses and the measurement value relating to the traffic situation of the own radio apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an outline of a base station system that uses radio equipment according to an embodiment;

FIG. 2 is a diagram illustrating a frame structure (a transmission frame structure) of a physical layer (Layer 1) in a CPRI specification;

FIG. 3 is a diagram illustrating 256 basic frames that constitute one hyper-frame in the CPRI specification;

FIG. 4 is a diagram illustrating a subchannel structure for control words in the CPRI specification;

FIG. 5 is a diagram illustrating a characteristic of a CPRI interface;

FIGS. 6A and 6B are diagrams illustrating an example (a first example) of a structure of a basic frame in the CPRI interface;

FIG. 7 is a diagram illustrating an example (a second example) of the structure of the basic frame in the CPRI interface;

FIG. 8 is a diagram illustrating an example of a configuration of a base station system that uses radio equipment according to a first embodiment;

FIG. 9 is a diagram illustrating an example of a flow of processing on a downlink basic frame in the radio equipment according to the first embodiment;

FIG. 10 is a diagram illustrating an example of a range of division blocks in the basic frame;

FIG. 11 is a diagram illustrating an example of a storage position of a measurement value in the subchannel structure for control words;

FIG. 12 is a diagram illustrating an example of contents of a measurement value table;

FIG. 13 is a diagram illustrating an example of a flow of processing on an uplink basic frame in the radio equipment according to the first embodiment;

FIG. 14 is a diagram illustrating an example of a flow of area selection processing in the radio equipment according to the first embodiment;

FIG. 15 is a diagram illustrating an example (a first example) of contents of a rank table that is used for description of the radio equipment according to the first embodiment;

FIG. 16 is a diagram illustrating an example (a first example) of a detail of a result of the area selection that is used for the description of the radio equipment according to the first embodiment;

FIG. 17 is a diagram illustrating an example (a second example) of the contents of the rank table that is used for the description of the radio equipment according to the first embodiment;

FIG. 18 is a diagram illustrating an example (a second example) of the detail of the result of the area selection that is used for the description of the radio equipment according to the first embodiment;

FIG. 19 is a diagram illustrating an example of a flow of area selection processing in radio equipment according to a second embodiment;

FIG. 20 is a diagram illustrating an example of a flow of processing on a downlink basic frame in radio equipment according to a third embodiment; and

FIG. 21 is a diagram illustrating an example of a flow of processing on an uplink basic frame in the radio equipment according to the third embodiment.

### DESCRIPTION OF EMBODIMENTS

In order to cope with an increase in traffic due to an increase in the use of smartphones, in recent years, a network setup configuration has increasingly been employed in which one or more of indoor radio equipment are installed at each floor of a building and in which traffic generated by user equipment (UE) that are present at each floor is accommodated. Generally, one strand of optical cable for a CPRI interface is drawn from a radio equipment controller, which is installed in a central telephone exchange, to the building and a plurality of radio equipment are cascade-connected (multistage connections).

In this case, basic frames on the CPRI interface are sequentially transferred between each of the plurality of radio equipment that constitute a link structure in which the multistage connections are made, and thus transmission of IQ data associated with each of the radio equipment is performed. When a radio area is allocated individually to each of the radio equipment that constitute the multistage connection link structure, pieces of IQ data are transmitted that correspond to the number of radio areas corresponding to the number of radio equipment. Because of this, an amount of IQ data that are transmitted on the CPRI interface becomes huge. For that reason, in order to transmit the huge amount of IQ data within a prescribed time, speed-up of a transmission rate of the CPRI interface is demanded. However, there is a concern that the speed-up of the transmission rate of the CPRI interface will bring about an increase in power consumption and a rise in hardware price.

On the other hand, it is rare that the traffic is evenly present in the radio area that is provided by each of radio equipment, and it is not unusual that the traffic is unevenly distributed to some of the radio areas. For this reason, although the transmission rate of the CPRI interface is sped up, an introduction cost and an operating cost can serve no purpose without a radio resource being effectively. For that reason, in a base station system in the related art, in a case where a plurality of radio equipment that are connected to the radio equipment controller are aggregated on one CPRI interface, there is a problem in that excessive power consumption that does not keep pace with actual traffic demand is inevitably caused.

Acccording to one aspect of the present disclosure, an object is to provide a solution technique in which one or several radio equipment among a plurality of radio equipment provide one or more shared radio areas and thus a transmission rate of a CPRI interface between a radio equipment controller and radio equipment can be reduced.

Embodiments will be described below with reference to the drawings. A configuration of the embodiment is an example, and no limitation to the configuration of the embodiment is imposed.

### First Embodiment

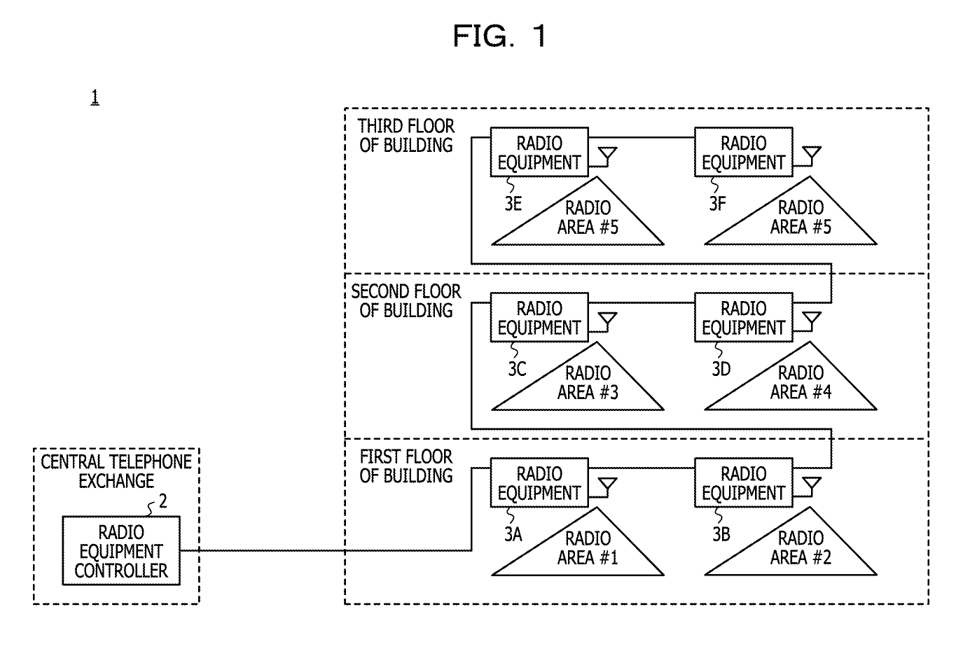

FIG. 1 is a diagram illustrating an example of an outline of a base station system that uses radio equipment according to a first embodiment. The radio equipment may be referred to as a radio apparatus. A base station system 1 that is illustrated in FIG. 1 includes a radio equipment controller 2 and a plurality of radio equipment 3 (3A to 3F). In an example in FIG. 1, only two of radio equipment 3 are installed in each floor of three-story building, and a total of six radio areas (#1 to #6) are formed within the building. According to the present embodiment, each radio area is categorized as any of a type of individual area and a type of shared area. The individual area is a radio area that is provided by a certain radio equipment 3, and refers to a radio area that is not shared among a plurality of radio equipment 3. On the other hand, the shared area refers to a radio area that is provided by two or more of radio equipment 3 using pieces of downlink IQ data that have the same contents. Two or more of radio equipment 3 that provide the same shared areas transmit radio signals that carry the same pieces of IQ data from transmit and receive antennas of the two or more of radio equipment 3, respectively, and thus each of the radio areas is formed. In other words, the user equipment (UE) that serves a certain radio area can recognize the radio signals that are transmitted by the two or more of radio equipment 3 which provide the same shared areas, as the radio signal in one radio area. It is noted that the radio area is also referred to as a cell or a sector. The IQ data is an example of a data signal that is transmitted on the CPRI interface between the radio equipment and the radio equipment controller.

The radio equipment controller 2 is equivalent to a base band signal processing unit that is a function (an element) of radio base station. Each of the plurality of radio equipment 3 is equivalent to radio processing unit that is a function of the radio base station. In the base station system, the radio equipment controller 2 and the plurality of radio equipment 3 are connected to each other in a manner that makes communication possible, using an electric or optical serial interface (CPRI interface) which is referred to as a common public radio interface (CPRI). Each of the radio equipment controller 2 and the plurality of radio equipment 3 in the base station system is also referred to as a node. It is noted that, as will be described below, the term “node” collectively refers to the radio equipment controller 2 and the plurality of radio equipment 3 in some cases, and mainly refers to the plurality of radio equipment 3 in some cases. Furthermore, the term “the number of nodes” mainly means the number of radio equipment 3.

A plurality of radio equipment 3 that are illustrated in FIG. 1 make serial connections (which are also referred to cascade connections or multistage connections) to the radio equipment controller 2. That is, a radio equipment 3A is connected to the radio equipment controller 2 as a front stage node, and is connected to a radio equipment 3B as a rear stage node. The radio equipment 3B is connected to the radio equipment 3A as a front stage node, and is connected to a radio equipment 3C as a rear stage node. The radio equipment 3C is connected to the radio equipment 3B as a front stage node, and is connected to a radio equipment 3D as a rear stage node. The radio equipment 3D is connected to the radio equipment 3C as a front stage node, and is connected to a radio equipment 3E as a rear stage node. The radio equipment 3E is connected to the radio equipment 3D as a front stage node, and is connected to a radio equipment 3F as a rear stage node. Then, the radio equipment 3F is connected to the radio equipment 3E as a front stage node. It is noted that, in a configuration example that is illustrated in FIG. 1, because the radio equipment 3F is located at end of the link structure, a rear stage node is not connected to the radio equipment 3F.

The radio equipment controller 2 is connected to a core node that is not illustrated, in a manner that makes communication possible, through a transmission path that is different from a transmission path to the plurality of radio equipment 3, and can receive from the core node a downlink (DL) signal that is destined for UE which serves radio areas (cells and the sectors) (#1 to #6) that are provided by the plurality of radio equipment 3, or can transmit to the core node one or several of, or all of the uplink (UL) signals from the UE, which are received by each of the plurality of radio equipment 3. The radio equipment controller 2 can modulate in a predetermined modulation scheme the DL signal that is destined for the UE which serves the radio areas (#1 to #6) that are provided by the plurality of radio equipment 3, respectively. The modulated DL signal is expressed as in-phase/quadrature (I/Q) data that takes an I value which is a same phase (in-phase) component and a Q value which is an orthogonal phase (quadrature) component and is transmitted to the plurality of radio equipment 3 through a protocol (a CPRI link) on the CPRI interface. That is, the IQ data is transmitted to the radio equipment 3, in a state of being stored in a transmission frame on the CPRI interface. The IQ data in each of a plurality of radio areas can be stored in one transmission frame. It is noted that user data, a control signal, a reference signal, a synchronization signal, and the like can be included in the IQ data.

Each of the plurality of radio equipment 3 acquires the IQ data that corresponds to the radio area which is provided by the own node, which itself is the radio equipment 3, from the transmission frame that is received through the CPRI link from the front stage node, such as the radio equipment controller 2 or the radio equipment 3. Then, each of radio equipment 3 performs predetermined radio processing, such as distortion compensation, orthogonal modulation, or frequency conversion (up-conversion), on the acquired IQ data. Thus, each of radio equipment 3 generates a radio signal in a predetermined frequency band, amplifies the generated radio signal to a predetermined transmit power using a transmission amplifier, and then transmits the resulting radio signal from the transmit and receive antenna. Furthermore, in a case where the rear stage node is connected, the radio equipment 3 transfers the transmission frame, which is received from the front stage node through the CPRI link, to the rear stage node. Accordingly, the transmission frame that is transmitted on the CPRI interface from the radio equipment controller 2 is sequentially transferred from the front stage node to the rear stage node.

On the other hand, the radio signal, which is transmitted from the UE that serves the radio area which is provided by each of the plurality of radio equipment 3 and is received in the transmit and receive antenna of each of the plurality of radio equipment 3, goes through a reception amplifier (a low-noise amplifier) or the like, and then predetermined radio processing, such as frequency conversion (down-conversion), or orthogonal demodulation (orthogonal detection), is performed on the radio signal that goes through the reception amplifier. Thus, the resulting radio signal is converted into IQ data that takes an I value that is a same phase (in-phase) and a Q value that is an orthogonal phase (the quadrature). Each of the plurality of radio equipment 3 transmits the IQ data that results from converting the radio signal which is received from the transmit and receive antenna, to the front stage node through the CPRI link that is an uplink, in a state of being stored in the transmission frame on the CPRI link. Accordingly, the IQ data indicating a UL signal that is transmitted from the UE is sequentially transferred from the front stage node to the rear stage node, and is transmitted to the radio equipment controller 2. Each of the plurality of radio equipment 3 sequentially transmits the transmission frame on the CPRI interface to the front stage node, and thus the radio equipment controller 2 can receive the transmission frame in which the IQ data that results from each of radio equipment 3 converting the received radio signal is stored, and can perform base band processing on the IQ data that is acquired from the transmission frame.

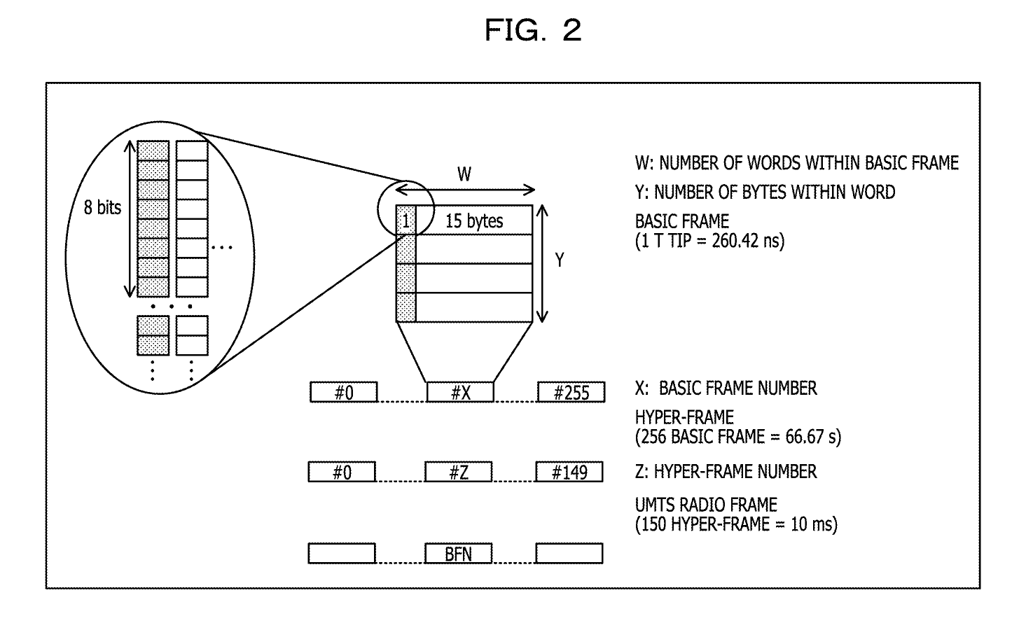

FIG. 2 is a diagram illustrating a frame structure (a transmission frame structure) of a physical layer (Layer 1) in a CPRI specification. In the transmission frame structure in the CPRI specification, a basic frame that is configured with 16 words that are expressed by index W=0 to 15 is set to be a transmission unit, and one hyper-frame is configured with 256 basic frames that are expressed by index X=0 to 255, and one “CPRI 10 ms frame (radio frame)” is configured with 150 hyper-frames that are expressed by index Z=0 to 149.

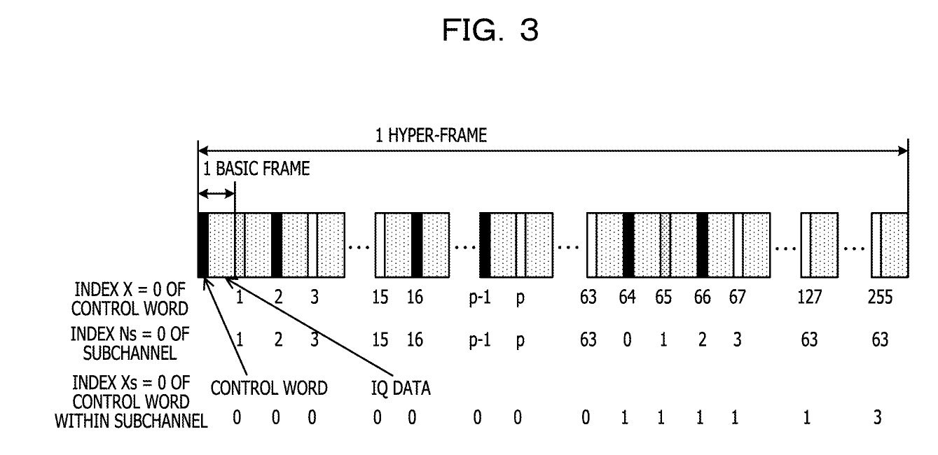

In the basic frame, a word that is expressed by index W=0 is a control word, and is an element for constituting a subchannel in the CPRI link. FIG. 3 illustrates 256 basic frames that constitute one hyper-frame in the CPRI specification. Because each basic frame includes the control word in the head thereof, one hyper-frame has a total of 256 control words. These 256 control words form 64 subchannels that are expressed by index Ns=0 to 63, and each subchannel has 4 control words that are expressed by index Xs=0 to 3.

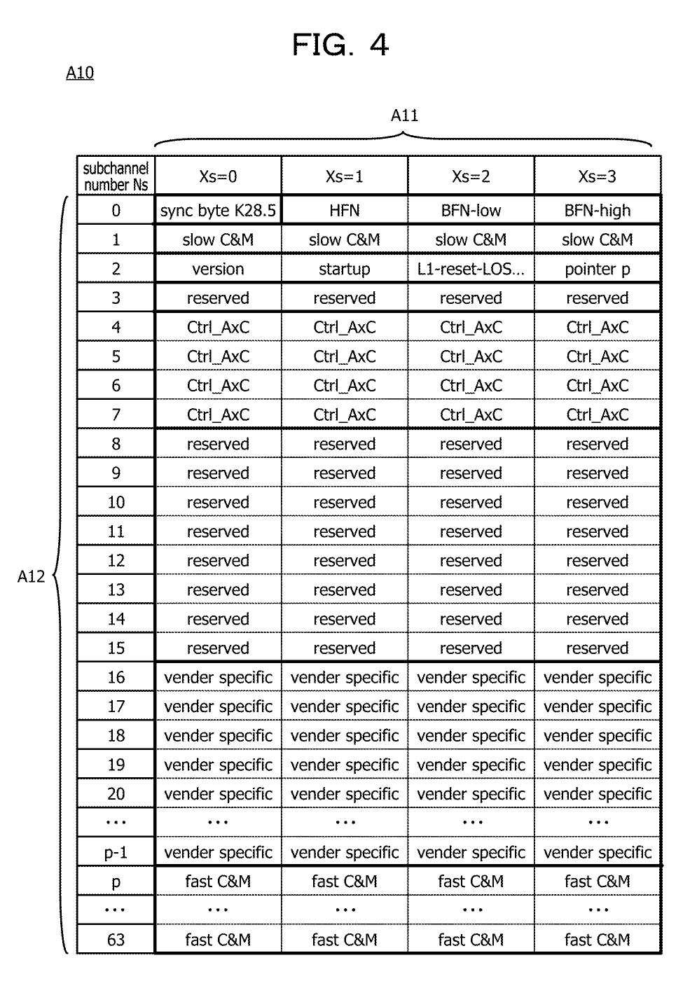

FIG. 4 illustrates a subchannel structure (A10) for control words in the CPRI specification, in a two-dimensional format in which index Xs's (A11) that expresses control words within the subchannel are arranged side by side on the horizontal axis and index Ns's (A12) for subchannels are arranged side by side on the vertical axis. Roughly speaking, in FIG. 4, a control word that is expressed by [Ns, Xs]=[0, 0] is a synchronization signal K28.5 (comma code). Three control words that are expressed by [Ns, Xs]=[0, 1], [0, 2], [0, 3] constitute an index value (a sequential number) of the hyper-frame or an index value (a sequential number) of the basic frame. Four control words that are expressed by [Ns, Xs]=[1, 0], [1, 1], [1, 2], [1, 3] are slow C&M links. A control word that is expressed by [Ns, Xs]=[2, 3] is a pointer (a pointer to start off fast C&M) p pointing to a subchannel Ns that is a starting position of fast C&M, within the hyper-frame. Subchannels that are expressed by Ns=3 and 8 to 15 are for control words that are reserved in compliance with the CPRI specification. Subchannels from Ns=16 up to and including a subchannel that the pointer p points to are vendor specific. Subframes from the subframe that the pointer p points to up to and including Ns=63 are fast C&M links.

In FIG. 2, the remaining words (W=1 to 15) in the basic frame are data words (an IQ data block) that are used for the transmission of the IQ data. A length T (in the vertical direction in FIG. 2) of each word can change with the transmission rate of the CPRI interface. In an example in FIG. 2, the frame structure in a case where a word length is 32 bits (8 bits×4) is illustrated. In this case, a data capacity of the data block within one basic frame is 480 bits (32 bit×15 words).

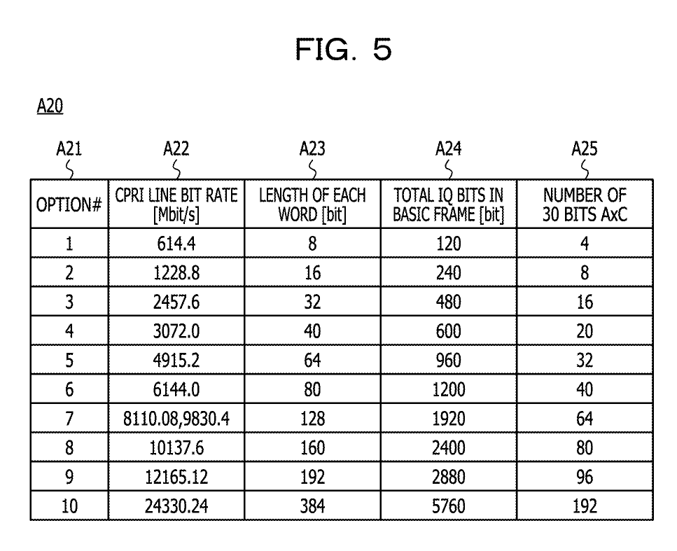

FIG. 5 is a diagram illustrating a characteristic (A20) of the CPRI interface. In FIG. 5, an example of a correspondence relationship between a transmission rate (A22) and a word length (A23) of the CPRI interface is illustrated. That is, in a characteristic example (A20) in FIG. 5, an option number (A21) that is an index value of each correspondence relationship, a transmission rate (A22) of the CPRI interface, a word length (A23), an IQ data block length (A24) within one basic frame, and the number (A25) of antenna carrier (A×CC) containers that are division areas that result from dividing the IQ data block within one basic frame by a 30 bit length are illustrated. For example, in an example of the option number “1”, it is illustrated that the transmission rate is 614.4 Mbit/s, the word length T is 8 bits, the IQ data block length is 120 bits (that is, 8 bits×15 words), the number of A×C's is 4 (that is, 120 bits/30 bits). In this example, in a case where each radio area is configured using two transmit and receive antennas, when one A×C container is allocated to each antenna, there are two radio areas that are capable of accommodation. It is noted that the number of A×C containers that are allocated to each antenna can change with a system bandwidth of a radio system. For example, in a case where the system bandwidth is 2.5 MHz, one A×C container with a 30 bit length is allocated to each antenna. On the other hand, because, in theory, an amount of IQ data that are transmitted is increased to 8 times in a case where the system bandwidth is 20 MHz, compared with a case where the system bandwidth is 2.5 MHz, the number of A×C containers, each with the 30 bit length, that are allocated to each antenna is 8.

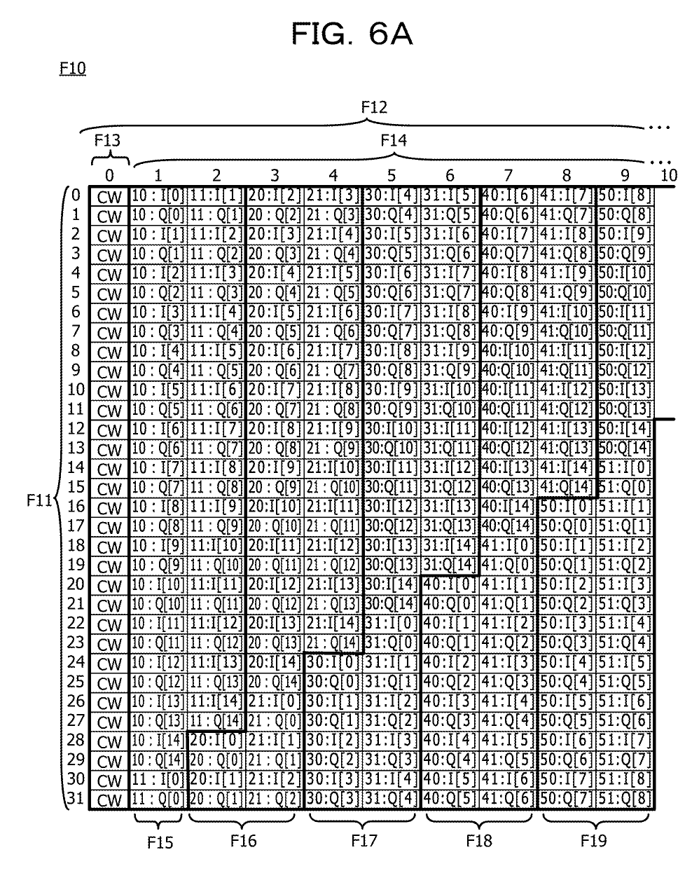

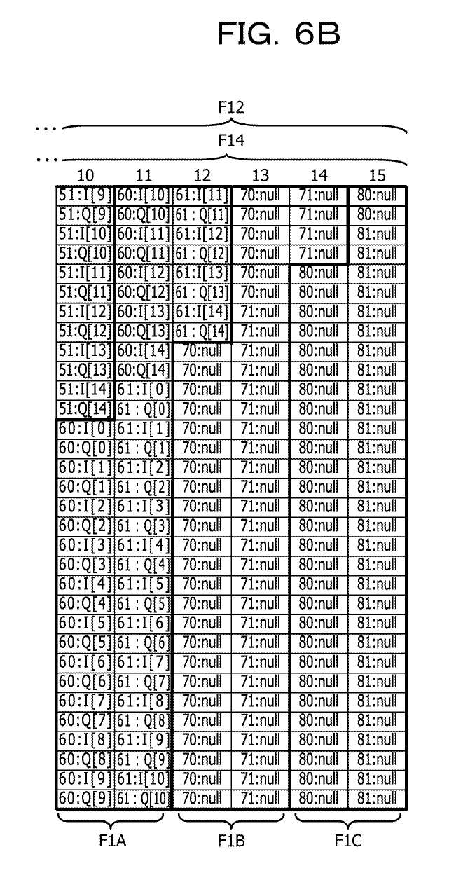

From an example that is illustrated in FIG. 5, it is understood that, in a case where a radio service in a system band of 2.5 MHz is provided using two transmit and receive antennas in each of the 6 radio areas, because 12 A×C containers are desirable that correspond to a total of 12 transmit and receive antennas, respectively, a transmission rate that is equal to or higher than a transmission rate 2457.6 Mbits/s that is indicated by option number “3” is desired as a transmission rate of the CPRI interface between the radio equipment controller 2 and the radio equipment 3. FIG. 6 (i.e. FIG. 6A and FIG. 6B) is a diagram illustrating an example (a first example) of a structure of the basic frame in the CPRI interface in this case. In the example (F10) of the structure of the basic frame in FIG. 6, each of the 16 words (F12) that constitute the basic frame has a 32-bit word length (F11), and has control words (F13) each of which is one word in the head of the basic frame, and IQ data blocks (F14) each of which has 15 words. The IQ data block (F14) that is illustrated in FIG. 6 is divided into 8 blocks (F15 to F1C), with a total of 60 bits (that is, two A×C containers), which correspond to an amount of IQ data that is allocated to each of the two transmit and receive antennas, being set to be one unit, and the resulting 8 blocks are associated with the radio areas, respectively (in some cases, the IQ data block that results from the division, which is associated with the radio area, is hereinafter referred to as a division block). It is noted that, among the division blocks, two blocks (F1B and F1C) in the rear are not allocated, and thus are set to a null value.

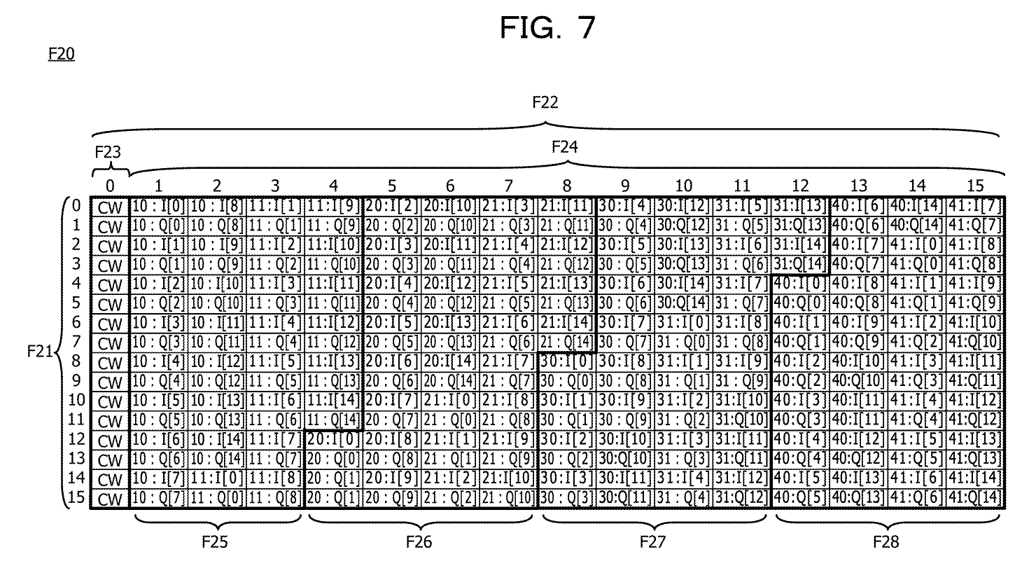

With reference again to FIG. 5, in a case where the number of radio areas is decreased to 4, because 8 A×C containers (4 areas×2 blocks) result, it is understood that the transmission rate of the CPRI interface is a transmission rate of 1228.8 Mbit/s that is indicated by option number “2”. FIG. 7 is a diagram illustrating an example (a second example) of the structure of the basic frame in the CPRI interface in this case. In the example (F20) of the structure in FIG. 7, each of the 16 words (F22) that constitute the basic frame has a 16-bit word length (F21), and has control words (F23) each of which is one word in the head of the basic frame, and IQ data blocks (F24) each of which has 15 words. The IQ data block (F24) that is illustrated in FIG. 7 is divided into 4 division blocks (F25 to F28), with the total of 60 bits (that is, two A×C containers), which correspond to the amount of IQ data that is allocated to each of the two transmit and receive antennas, being set to be one unit, and the resulting 4 division blocks are associated with the radio areas, respectively. It is noted that, in the example in FIG. 7, the division block that is not allocated is not present.

With reference again to FIG. 5, it is understood that, because the number of A×C containers that are desirable in the case where the system bandwidth is set to 20 MHz is 8 times the number of A×C containers in the case where the system bandwidth is 2.5 MHz, 96 A×C containers (12 antennas×8) that correspond to each of 12 transmit and receive antennas are desirable in six radio areas, and that the transmission rate of the CPRI interface is a transmission rate of 12165.12 Mbit/s that is indicated by option number “9”. In contrast, it is understood that, in the system bandwidth of 20 MHz, in a case where two transmit and receive antenna units are used in each of the four radio areas, the number of A×C's that are desirable is 64 (8 antennas×8), and for example, a transmission rate of 8110.08 Mbit/s, which is indicated by option number “7”, results.

As illustrated in the plurality of examples, a configuration can be employed in which the transmission rate of the CPRI interface is more lowered in a case where an amount of IQ data that is transmitted between the radio equipment controller 2 and the radio equipment 3 is limited to an amount that is equivalent to four radio areas than in a case where an amount of IQ data that corresponds to six radio areas is transmitted. By employing the configuration in which the transmission rate of the CPRI interface is lowered, an amount of consumption of electric power relating to the CPRI interface between the radio equipment controller 2 and the radio equipment 3 in the base station system can be suppressed. Furthermore, because, generally, the higher the transmission rate, the more increased is the cost of manufacturing hardware, in some cases, from the perspective that the introduction cost of the base station system is lowered, it is desirable that the transmission rate of the CPRI interface results in being low.

However, in some cases, in order to maintain and secure a coverage range of a radio area within a building to a certain degree of radio quality, it is desirable that a plurality of transmit and receive antennas are installed within the building. In the example in FIG. 1, if six radio areas are formed and it is assumed that two transmit and receive antennas are used in each radio area, the transmission rate of the CPRI interface at which the A×C containers that correspond to a total of 12 antennas can be transmitted is demanded. Nevertheless, as utilization characteristics of the radio areas that are formed within the building, it is rare that the UE's that serve the radio areas within the building are evenly distributed in the areas, respectively, and it is not unusual that the UE's are unevenly distributed to a certain radio area due to factors, such as a time zone and a day of the week. For example, during the lunch time, the UE that, during working hours, serves the radio area that is formed in each office is moved in a concentrated manner to a radio area that is formed in a cafeteria within the building, and thus traffic for radio communication can be unevenly distributed to a specific radio area, during the working hours, the lunch time, and the like. For this reason, while it is desirable to secure the coverage range of the radio area within the building, it may not be possible to say that resources in all radio areas are effectively used as is illustrated in the example of the uneven distribution of the traffic described above.

Accordingly, according to an aspect of the present embodiment, a solution technique can be provided in which one or several radio equipment among a plurality of radio equipment 3 provide a shared radio area (a shared area), without each of the plurality of radio equipment 3 evenly providing an individual radio area (an individual area), and thus the transmission rate of the CPRI interface between the radio equipment controller 2 and the radio equipment 3 can be reduced. Furthermore, according to another aspect of the present embodiment, a solution technique is provided in which each of the plurality of radio equipment 3 can autonomously determine whether or not the radio equipment has to operate as radio equipment that provides a shared area, according to comparison with traffic situations of other radio equipment.

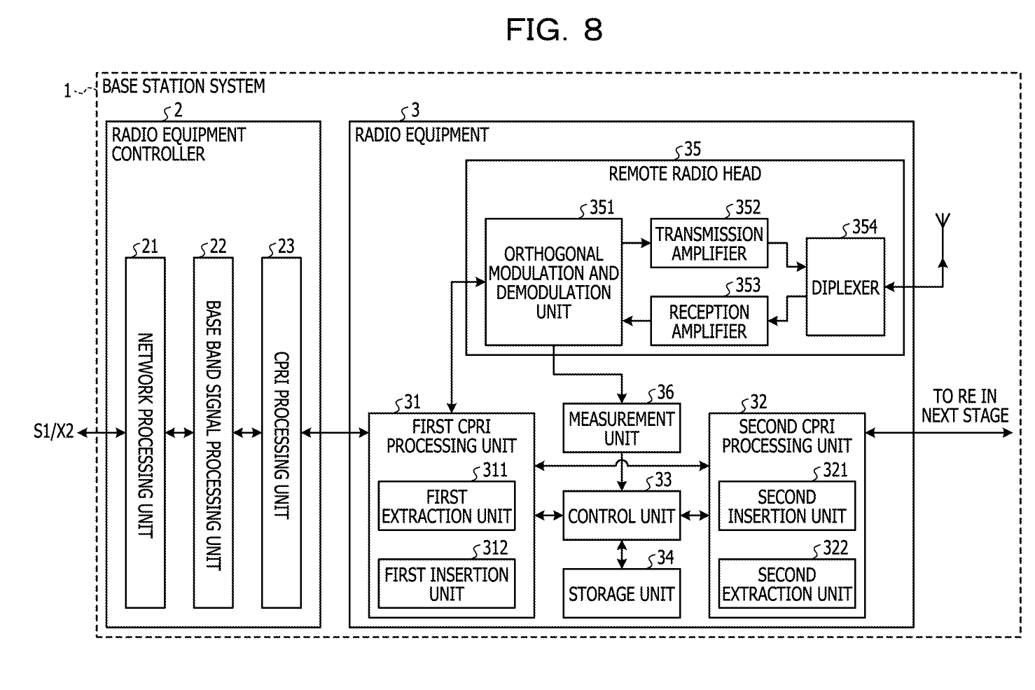

FIG. 8 is a diagram illustrating an example of a configuration of the base station system 1 that uses the radio equipment 3 according to the present embodiment. It is noted that, in an example in FIG. 8, one of radio equipment 3 is illustrated and an illustration of another radio equipment 3 is omitted. The base station system 1 that is illustrated in FIG. 8 includes the radio equipment controller 2 and a plurality of radio equipment 2.

The radio equipment controller 2 that is illustrated in FIG. 8 includes a network processing unit 21, a base band signal processing unit 22, and a CPRI processing unit 23. The network processing unit 21 has a function of processing an S1 interface that is used for communication with a core node, such as mobility management entity (MME) or serving-gate way (S-GW), or an X2 interface or the like that is used for communication with another radio equipment controller 2, through a transmission path that is different from a transmission path that acts as an intermediary for communication with a plurality of radio equipment 3. The network processing unit 21 can receive from the core node the DL signal that is destined for the UE which serves the radio areas that are provided by the plurality of radio equipment 3, or can transmit to the core node one or several of, or all of the UL signals from the UE, which are received by each of the plurality of radio equipment 3.

The base band signal processing unit 22 has a function of modulating the DL signal that is destined for the UE, which is received from the core node through the network processing unit 21, in a predetermined modulation scheme, using a processor, such as a digital signal processor (DSP) or a field programmable gate array (FPGA), and converting the resulting DL signal into the IQ data signal. Furthermore, the base band signal processing unit 22 has a function of demodulating the IQ data for an uplink, which is received from each of radio equipment 3 through the CPRI processing unit 23, using the processor, and converting the resulting IQ data into the UL signal from each of UE.

The CPRI processing unit 23 has a function of receiving the IQ data for the downlink from the base band signal processing unit 22, and transmitting the received IQ data to the radio equipment 3, in a state of being stored in the transmission frame on the CPRI interface. Furthermore, the CPRI processing unit 23 has a function of receiving the transmission frame on the CPRI interface from the radio equipment 3, acquiring uplink IQ data, which is stored in the transmission frame, and supplying the acquired IQ data to the base band signal processing unit 22. Furthermore, the CPRI processing unit 23 has a function of establishing synchronization on the CPRI interface between each of the plurality of radio equipment 3, or a function of measuring transmission delay and compensating for an amount of delay. These functions are functions that are well known to a person of ordinary skill in the related art, and thus, detailed descriptions thereof are omitted.

Next, a configuration of the radio equipment 3 that is illustrated in FIG. 8 is described. The radio equipment 3 includes a first CPRI processing unit 31, a second CPRI processing unit 32, a control unit 33, a storage unit 34, and a remote radio head 35. The first CPRI processing unit 31 has a function of transmitting and receiving the transmission frame on the CPRI interface to and from the front stage node (the radio equipment controller 2 or the radio equipment 3). That is, the first CPRI processing unit 31 can be connected to the CPRI processing unit 23 of the radio equipment controller 2, or the second CPRI processing unit 32 of the radio equipment 3, in a manner that makes communication possible, using an electric or optical serial interface.

The first CPRI processing unit 31 that is illustrated in FIG. 8 includes a first extraction unit 311 and a first insertion unit 312. The first extraction unit 311 has a function of extracting the IQ data that is stored in the division block which corresponds to the radio area that is provided by the own node from the transmission frame that is received from the front stage node, and supplying the extracted IQ data to the remote radio head 35. Furthermore, the first extraction unit 311 has a function of extracting a measured value relating to a traffic situation that is measured in the front stage node, from the control word in a predetermined area of the transmission frame from the front stage node, and supplying the extracted measurement value to the control unit 33, in a case where the front stage node is another radio equipment 3. The first insertion unit 312 has a function of inserting the IQ data of the UL signal that is supplied from the remote radio head 35, into a predetermined division block of the transmission frame that is transmitted from the first CPRI processing unit 31 to the front stage node. Furthermore, the first insertion unit 312 has a function of storing the measurement value relating to the traffic situation of the own node, which is measured in a measurement unit 36, in a predetermined area of the control word in an uplink transmission frame. These functions may be realized by executing a program that is stored in the storage unit 34 or a storage unit (whose illustration is omitted) within the first CPRI processing unit 31, in a processor, such as a central processing unit (CPU), a DSP, and FPGA. In other words, a hardware circuit that realizes the functions described above can be generated by executing a predetermined program in the processor.

The second CPRI processing unit 32 that is illustrated in FIG. 8 has a function of transmitting and receiving the transmission frame on the CPRI interface to and from the rear stage node (another radio equipment 3). That is, the second CPRI processing unit 32 can be connected to the first CPRI processing unit 31 of another radio equipment 3 in a manner that makes communication possible, using an electric or optical serial interface. In an example that is illustrated in FIG. 8, the second CPRI processing unit 32 includes a second insertion unit 321 and a second extraction unit 322. The second insertion unit 321 has a function of storing the measurement value relating to the traffic situation of the own node, which is measured with the measurement unit 36, in a predetermined area of the control word in the transmission frame that is transferred by the second CPRI processing unit 32 to the rear stage node. The second extraction unit 322 has a function of extracting the measurement value relating to the traffic situation that is measured in the rear stage node, from the control word of a predetermined area of the transmission frame that is received from the rear stage node and supplying the extracted measurement value to the control unit 33. These functions may be realized by executing a program that is stored in the storage unit 34 or a storage unit (whose illustration is omitted) within the second CPRI processing unit 32, in a processor, such as a CPU, a DSP, and FPGA. In other words, a hardware circuit that realizes the functions described above can be generated by executing a predetermined program in the processor.

The control unit 33 that is illustrated in FIG. 8 has a function of receiving the measurement value relating to the traffic situation that is measured in the front stage node or the rear stage node, from the first extraction unit 311 of the first CPRI processing unit 31 or the second extraction unit 322 of the second CPRI processing unit 32, generating or updating a measurement value table T10, and causing the generated or updated measurement value table T10 to be stored in the storage unit 34. Furthermore, the control unit 33 has function of generating or updating the measurement value table T10 described above using the measurement value relating to the traffic situation that is measured in the measurement unit 36 of the own node and causing the generated or updated measurement value table T10 to be stored in the storage unit 34. Additionally, the control unit 33 has a function of comparing the measurement values relating to the traffic situations of the own node and another node, based on the measurement value table T10 that is generated or updated by the functions described above, and determining whether the radio area that is provided to the UE by the own node has to be set to be an individual area or a shared area. Then, the control unit 33 has a function of providing the first CPRI processing unit 31 and/or the second CPRI processing unit 32 with an instruction that a position of the division block which has to be referred to has to be changed, in a case where a result of the determination by the function described above indicates that a type (that is, the individual area or the shared area) of radio area which is provided by the own node has to be changed. These functions may be realized by executing a program that is stored in the storage unit 34 or a storage unit (whose illustration is omitted) within the control unit 33, which prescribes processing relating to the present embodiment, in a processor, such as a CPU, a DSP, and FPGA. In other words, a hardware circuit that realizes the functions described above can be generated by executing a predetermined program in the processor.

The storage unit 34 that is illustrated in FIG. 8 is configured in such a manner that a program, data, or the like that prescribes the processing relating to the first embodiment is stored in the storage unit 34, and is connected to the control unit 33 in a manner that makes communication possible. As examples of the storage unit 34, a random access memory (RAM), a read only memory (ROM), a solid state drive (SSD), a hard disk drive (HDD), and the like are given. It is noted that, in the example that is illustrated in FIG. 8, only a connection between the storage unit 34 and the control unit 33 is illustrated, but for example, a configuration may be employed in such a manner that a connection between an element, such as the first CPRI processing unit 31, the second CPRI processing unit 32, the remote radio head 35, or the measurement unit 36, and the storage unit 34 is also established.

The remote radio head 35 that is illustrated in FIG. 8 includes an orthogonal modulation and demodulation unit 351, a transmission amplifier 352, a reception amplifier 353, and a duplexer 354. It is noted that, as a modification example, instead of the duplexer 354, a switch, a combination of a switch or a duplexer, or the like may be used. The remote radio head 35 has a function of acquiring the downlink IQ data that corresponds to the radio area which is provided by the own node from the first CPRI processing unit 31, performing the orthogonal modulation on the IQ data using the orthogonal modulation and demodulation unit 351, performing the radio processing, such as the frequency conversion (the up-conversion), if desirable, and thus generating a radio signal in a predetermined frequency band. Additionally, the remote radio head 35 has a function of amplifying the generated radio signal to a preset transmit power using the transmission amplifier 352 and then transmitting the resulting radio signal from the transmit and receive antenna through the duplexer 354 or the like. Furthermore, the remote radio head 35 has a function of inputting an uplink radio signal that is received in the transmit and receive antenna, into the orthogonal modulation and demodulation unit 351 through the duplexer 354, the reception amplifier 353, and the like, performing predetermined radio processing, such as the orthogonal demodulation (the orthogonal detection), and thus converting the resulting uplink radio signal into IQ data that takes an I value that is a same phase (in-phase) and a Q value that is an orthogonal phase (the quadrature). The remote radio head 35 supplies the uplink IQ data that results from converting the radio signal, to the first CPRI processing unit 31, and thus can transmit the IQ data to the radio equipment controller 2 through the radio equipment 3 of the front stage node, in a state of being stored in the uplink transmission frame. Furthermore, the remote radio head 35 supplies the uplink IQ data to the measurement unit 36, and thus can cause the measurement unit 36 to measure the traffic situation of the own node.

The measurement unit 36 that is illustrated in FIG. 8 has a function of acquiring the uplink IQ data from the remote radio head 35, and calculating the measurement value relating to the traffic situation of the own node, using a plurality of IQ data during a predetermined measurement period of time (for example, 0.5 ms that is equivalent to one slot in a radio frame structure in compliance with Long Term Evolution (LTE)). For example, the measurement unit 36 may accumulate signal strengths that are indicated by pieces of IQ data of a plurality of samples during a measurement period of time, and thus may obtain the measurement value relating to the traffic situation of the own node. For example, measurement value=√(Î2+Q̂2 may be computed, and measurement value=√(Î2+Q̂2) may be computed. A method of obtaining the measurement value is not limited to these examples, any value in which at least one of the I value that is a same phase (in-phase) and the Q value that is an orthogonal phase (the quadrature) is reflected can be used as the measurement value relating to the traffic situation. It is noted that, according to the present embodiment, the reason why the signal strength of the uplink IQ data is referred to as the measurement value relating to the traffic situation is as follows. That is, a radio communication system in compliance with an LTE scheme, a wideband code division multiple access (WCDMA) scheme, or the like, in which multi-access that enables information to be transmitted with a plurality of subcarrier signals being shared among a plurality of UEs is possible, the more increased is the number of UEs that transmit the radio signal more, the more increased is the signal strength of the uplink IQ data that is received in the radio equipment 3 during the measurement period of time. For this reason, it can be said that the greater the value that is indicated by the signal strength of the IQ data during the measurement period of time, the larger amount of consumption radio resources is present in the traffic situation. Furthermore, the more increased is the number of UEs that receives the user data in the downlink, the more increased is the number of UEs that reply with an ACK signal in the uplink or the number of UEs that transmit a report on a result of measurement of a reception environment. For that reason, the signal strength of the uplink IQ data can be used also as an index indicating the traffic situation in the downlink.

In order to acquire a timing at which the measurement period of time starts, the measurement unit 36 may be supplied with a measurement instruction signal from the first CPRI processing unit 31 and/or the control unit 33, according to a timing in the head of an uplink radio frame that is specified using a timing in the head of a downlink radio frame which is known with a sequence number (an index value) of downlink transmission frame, which is acquired from the front stage node, as a reference. For example, index number Z=0 of the hyper-frame and index number X=0 of the basic frame in the downlink transmission frame are equivalent to data in the head of the downlink radio frame. Therefore, the radio equipment 3 can obtain information on a timing at which data in the head of the frame is received, and can obtain an exact timing in the head of the downlink radio frame using an amount of delay compensation that is notified by the radio equipment controller 2 in an initial operation when the radio equipment 3 is activated. Furthermore, because the timing in the head of the uplink radio frame is synchronized with a timing that results from adding or subtracting a predetermined offset to and from a timing in the downlink, the radio equipment 3 can obtain information on the timing in the head of the uplink radio frame, from a timing in the head of the downlink radio frame.

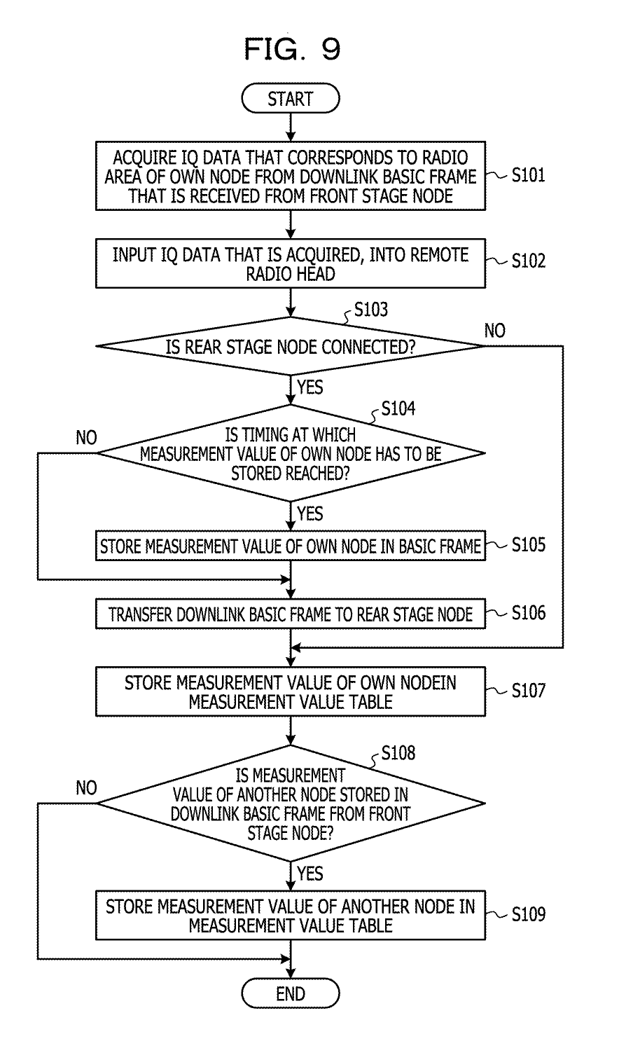

Next, an example of a flow of processing on a downlink basic frame in the radio equipment 3 according to the present embodiment is described with reference to FIG. 9. The flow of the processing that is illustrated in FIG. 9, for example, may be set to be repeatedly performed at a timing that is synchronized with a periodicity of the basic frame that is transmitted on the CPRI interface, and may be set to start to be performed according to the detection of the reception of the basic frame.

First, the first CPRI processing unit 31 of the radio equipment 3 acquires the IQ data that corresponds to the radio area which is provided by the own node, from the downlink basic frame that is received from the front stage node (S101). A method of acquiring the IQ data is described with reference to the configuration example (F20) of the basic frame of the CPRI interface that is illustrated in FIG. 7. In the example of the structure that is illustrated in FIG. 7, the IQ data block (F24) is configured with four division blocks (F25 to F28). According to the present embodiment, for example, among the four division blocks, three division blocks and one division block will be described below as individual areas, and a shared area, respectively.

In the example of the structure of the basic frame that is illustrated in FIG. 7, the IQ data of the individual area can be stored in three division blocks (F25 to F27) in the head, and the IQ data of the shared area can be stored in the remaining one division block (F28). That is, the IQ data of individual area #1 is stored in division block #1 (F25), the IQ data of individual area #2 is stored in division block #2 (F26), the IQ data of individual area #3 is stored in division block #3 (F27), and the IQ data of the shared area is stored in division block #4 (F28).

The IQ data that corresponds to each of the two transmit and receive antennas is stored in each division block. For example, when expressed with coordinates of an index value in a word direction and coordinates of an index value in a bit direction, the IQ data for one transmit and receive antenna is stored in a range of [1, 0] to [2, 13] in division block #1 (F25), and the IQ data for one transmit and receive antenna is stored also in a range of [2, 14] to [4, 11]. Therefore, it is easily understood by a person of ordinary skill in the related art that a size of the division block in the basic frame can differ with the number of transmit and receive antennas in the radio area.

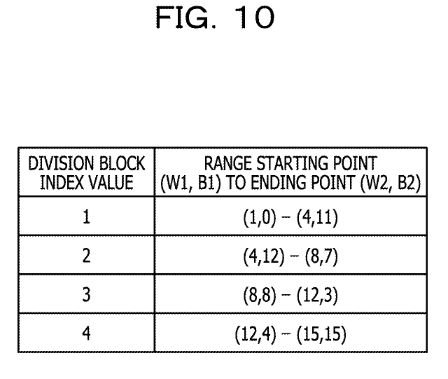

FIG. 10 is a diagram illustrating an example of a range of the division block in the basic frame. In an example in FIG. 10, a range of each division block is illustrated with the coordinates of the index value in the word direction and the coordinates of the index value in the bit direction. For example, division block #1 that has index value=1 is a data block in a range of [1, 0] to [4, 11] as described above. In other words, a data block from the 0-th bit of word #1 up to and including the 11-th bit of word #4 is a range of division block #1. Because this is true for other division blocks, descriptions thereof are omitted. The radio equipment 3 may store setting information indicating a division block index value and a range as illustrated in FIG. 10, in advance in the storage unit 34 or the like, and may specify a range that is specified with an index value of the division block that corresponds to the radio area which is provided by the own node, with reference to the setting information. Alternatively, the radio equipment 3, for example, may calculate coordinates of a starting point and coordinates of an ending point of the division block that has to be referred to, using Equations 1 to 4 that follow.

$$\begin{matrix}Starting point W 1 = ( ( Block\_Ind - 1 ) \times m ) mod T & ( Equation 1 ) \\ Starting point B 1 = ( ( Block\_Ind - 1 ) \times m ) mod T & ( Equation 2 ) \\ Ending point W 2 = ⌊ \frac{Block\_Ind \times m \times ATn [ Block\_Ind ] - 1}{T} ⌋ & ( Equation 3 ) \\ Ending point B 2 = ( Block\_Ind \times m - 1 ) mod T & ( Equation 4 )\end{matrix}$$

where Block_Ind is an index value of the division block that corresponds to the radio area that is provided by the own node, and is an integer that is equal to or greater than 1.

Atn[Block_Ind] is the number of antennas in the division block that is designated with index value Block_Ind. Variable m expresses a bit length of the IQ data per one sample, and T expresses a bit length of one word. In the example in FIG. 7, variable m is 30 bits (that is, m=30 [bit]), variable T is 16 bits (that is, T=16 [bit]), and Atn[Block_Ind] is 2 antennas (that is, Atn=2[antenna] per all division blocks). It is noted that, in Equation 1 and Equation 3, which are described above, symbol “└x540 ” means omission of fractions after a decimal point of a real number x. In other words, symbol “└x┘” means the greatest integer after a real number x. Equations 2 and 4, which are described above, symbol “mod” expresses a modulo operation. That is, Equation (a mod n) can be substituted by Equation (a−(n*┐a/n┘)).

Next, the first CPRI processing unit 31 of the radio equipment 3 inputs the acquired IQ data into the remote radio head 35 (S102). Accordingly, the remote radio head 35 of the radio equipment 3 can cause the radio signal in accordance with the IQ data to be synchronized with a predetermined timing, and thus can transmit the resulting radio signal from the transmit and receive antenna.

In a case where the rear stage node is connected (YES in S103), the radio equipment 3 determines whether or not the basic frame from the front stage node corresponds to the timing at which the measurement value of the own node has to be stored (S104). For example, in a case where an index value X of the basic frame from the front stage node is acquired from the first CPRI processing unit 31 and the index value X of the basic frame is consistent with a timing X0 that is allocated to the own node, the control unit 33 of the radio equipment 3 can determine that the basic frame from the front stage node corresponds to a timing at which the measurement value of the own node has to be stored (YES in S104).

In a case where it is determined that the basic frame from the front stage node corresponds to the timing at which the measurement value of the own node has to be stored (YES in S104), the radio equipment 3 stores the measurement value relating to the uplink traffic situation that is measured in the own node, in the control word on the basic frame (S105) and transfers the basic frame to the rear stage node (S106). For example, the control unit 33 of the radio equipment 3 may acquire the signal strength (the measurement value) that is obtained from a plurality of uplink IQ data which are acquired by the measurement unit 36 from the remote radio head 35 during a predetermined measurement period of time (for example, 0.5 ms that is equivalent to one slot in the radio frame structure in compliance with the LTE scheme), and may notify the second insertion unit 321 of the second CPRI processing unit 32 of the measurement value of the own node. Accordingly, the second CPRI processing unit 32 can store the measurement value of the own node, in the control word on the basic frame that is received by the first CPRI processing unit 31 from the front stage node, and can transfer the basic frame to the rear stage node. On the other hand, in a case where it is determined in Processing S104 that the basic frame from the front stage node does not correspond to the timing at which the measurement value of the own node has to be stored (NO in S104), the control unit 33 of the radio equipment 3 may not notify the second insertion unit 321 of the second CPRI processing unit 32 of the measurement value. Accordingly, the second CPRI processing unit 32 skips Processing S105 without performing Processing S105, and transfers the basic frame that is received by the first CPRI processing unit 31 from the front stage node, to the rear stage node (S106).

It is noted that, in a case where it is determined in Processing S103 that the rear stage node is not connected (NO in S103), Processing S104 to Processing S106 may be skipped without being performed. Accordingly, the second CPRI processing unit 32 does not perform processing that transfers the basic frame to the rear stage node. In Processing S103, in the determination of whether or not the rear stage node is not connected, for example, in a case where the synchronization with the rear stage node on the CPRI interface is established in the second CPRI processing unit 32, it may be determined that the rear stage node is connected. Alternatively, based on an index value (a node ID) of the own node, and the number of radio equipment 3 (the number of nodes) in the link structure in which the multistage connections are made, it may be determined whether or not the rear stage node is connected. For example, in a case where an ID of the own node is an integer value that is equal to or greater than 0, when the ID of the own node is less than [the number of nodes-1], it can be determined that the rear stage node is connected. It is noted that the radio equipment 3 may receive setting information that includes the node ID and the number of nodes, from the radio equipment controller 2 in a sequence for initialization with the radio equipment controller 2, and, based on the setting information from the radio equipment controller 2, may store the node ID and the number of nodes. The setting information can be transmitted from the radio equipment controller 2 to each of radio equipment 3 using the control word that constitutes the fast C&M.

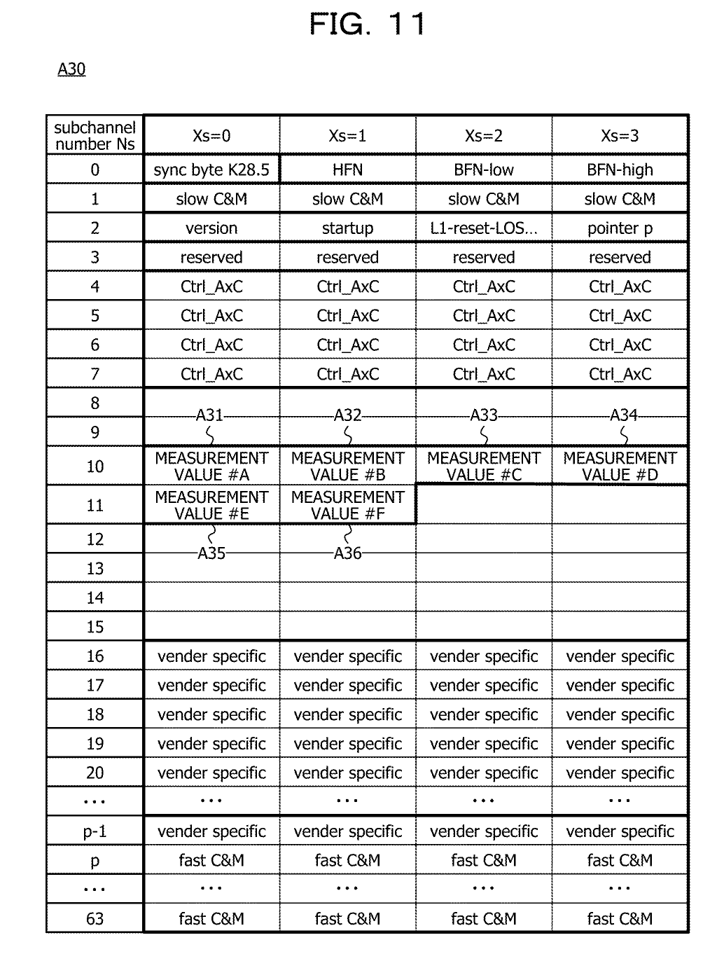

Next, a determination method in Processing S104 is described with reference to FIG. 11. FIG. 11 is a diagram illustrating an example of a storage position (a timing at which the measurement value of the own node has to be stored) of the measurement value in the subchannel structure (A30) for control words. According to the present embodiment, as an example of an area of the basic frame, in which the measurement value is stored, “reserved” that is a control word is used. As a modification example, for example, “vendor specific” that is a control word may be used. In an example in FIG. 11, measurement value #A of the radio equipment 3A is stored in a control word (A31) that is expressed by [Ns=10, Xs−0], measurement value #B of the radio equipment 3B is stored in a control word (A32) that is expressed by [Ns=10, Xs=1], measurement value #C of the radio equipment 3C is stored in a control word (A33) that is expressed by [Ns=10, Xs=2], measurement value #D of the radio equipment 3D is stored in a control word (A34) that is expressed by [Ns=10, Xs=3], measurement value #E of the radio equipment 3E is stored in a control word (A35) that is expressed by [Ns=11, Xs=0], and measurement value #F of the radio equipment 3F is stored in a control word (A36) that is expressed by [Ns=11, Xs=1]. The radio equipment 3, for example, can specify the control word that can be used for the storing of the measurement value of the own node, using Equations 5 and 6 that follow.

$$\begin{matrix}Ns = Ns\_Offset + ⌊ \frac{Node\_Ind}{4} ⌋ & ( Equation 5 ) \\ Xs = Xs\_Offset + ( Node\_Ind ) mod 4 & ( Equation 6 )\end{matrix}$$

where Node_Ind is an index value indicating a position of the own node in the link structure in which the multistage connections to a plurality of radio equipment 3 are made, and is an integer that is equal to or greater than 0.

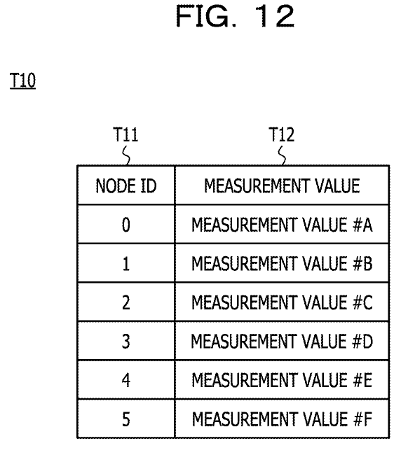

For example, in the example in FIG. 12, an index value of the radio equipment 3A is “0”, an index value of the radio equipment 3B is “1”, an index value of the radio equipment 3C is “2”, an index value of the radio equipment 3D is “3”, an index value of the radio equipment 3E is “4”, and an index value of the radio equipment 3F is “5”. Ns_Offset is an offset value in a subchannel Ns direction, and Ns_Offset in the example that is illustrated in FIG. 11 is 10 (that is, Ns_Offset=10). Xs_Offset is an offset value in an index value Xs direction of the control word within the subchannel, and is Xs_Offset in the example in FIG. 11 is 0 (that is, Xs_Offset=0).

The radio equipment 3 may perform computing that uses Equations 5 and 6, with the control unit 33, or with the second insertion unit 321. That is, the storage position that is specified by the computing in the control unit 33 may be notified by the control unit 33 to the second insertion unit 321. Alternatively, the control unit 33 may notify the second insertion unit 321 of the index value of the own node, and various offset values, and thus may specify the storage position that results from computing in the second insertion unit 321. It is noted that an index value X0 of the basic frame that has the control word which corresponds to a coordinate value that is indicated by Ns and Xs is X0=64 Xs+Ns. Instead of the method of specifying coordinates on the subchannel structure using Equations 5 and 6, which are described above, the index value of the basic frame may be directly calculated using Equation 7 that follows.

$$X 0 = 64 ( Xs\_Offset + ⌊ \frac{Node\_Ind}{4} ⌋ ) + ( Ns\_Offset + ( Node\_Ind ) mod 4 ) \qquad ( Equation 7 )$$

With any of the methods that are described above, the control unit 33 of the radio equipment 3 compares the index value X of the basic frame from the front stage node and the index value X0 indicating the timing at which the measurement value of the own node has to be stored, and, in a case where X=X0, can determine that the basic frame from the front stage node corresponds to the timing at which the measurement value of the own node has to be stored (YES in S104). It is noted that, in a case where the measurement period of time in the measurement unit 36, for example, is set to 0.5 ms, because a transmission periodicity of one hyper-frame (256 basic frames) that constitutes the subchannel structure for control words is 66.67 μs, a plurality of transmission timings of the measurement value of the own node come during one measurement period of time. The radio equipment 3 may repeatedly transmit the measurement values that are the same values, at a plurality of transmission timings during one measurement period of time. As a modification example, in Processing 104, for example, the control unit 33 of the radio equipment 3 may set the index value X0 that indicates the timing at which the measurement value of the own node, which is specified using the method that is described with reference to Equations 5 to 7, has to be stored, and the measurement value relating to the traffic situation of the own node, to be in an internal register of the second CPRI processing unit 32. In this case, the second CPRI processing unit 32 compares the index value X0 that is set to be in the internal register and the index value X of the basic frame from the front stage node, and in a case where X=X0, can determine that the basic frame from the front stage node corresponds to the timing at which the measurement value of the own node has to be stored (YES in S104). Furthermore, the second CPRI processing unit 32 can store the measurement value relating to the traffic situation of the own node, which is set to be in the internal register, in the control word of the basic frame (S105), and can transfer the basic frame to the rear stage node (S107).

It is noted that, based on the setting information that is received from the radio equipment controller 2 in the sequence of the initialization with the radio equipment controller 2, various parameters (the index value of the own node and various offset values) that are used in Equations 1 to 7, which are described above, are set for the radio equipment 3. These various parameters, which are pieces of setting information, can be transmitted from the radio equipment controller 2 to each of radio equipment 3 using the control word that constitutes the fast C&M.

With reference again to FIG. 9, the radio equipment 3 stores the measurement value of the own node, in the measurement value table T10 (S107). For example, the control unit 33 of the radio equipment 3 may update values in the measurement value table T10 that is stored in the storage unit 34, using the measurement value that is acquired from the measurement unit 36. FIG. 12 is a diagram illustrating an example of contents of the measurement value table T10. The measurement value table T10 that is illustrated in FIG. 12 has an information structure in which a node ID (T11) for identifying each of radio equipment 3 and a measurement value (T12) of another node, which is stored in the basic frame from the front stage node, are associated with each other. In an example that is illustrated in FIG. 12, as the node ID (T11), a node index value indicating a position of each of radio equipment 3 in the multistage connection link structure is used. According to the present embodiment, no limitation to this value may be imposed, and another piece of identification information for identifying the radio equipment 3 may be used.

With reference again to FIG. 9, the radio equipment 3 determines whether or not a measurement value of another node is stored in the downlink basic frame from the front stage node (S108). For example, the first extraction unit 311 of the radio equipment 3 can specify a position of the control word in which a measurement value of another node is stored, with the same procedure in the method of specifying the position of the control word in which the measurement value of the own node is stored. For example, an index value of another node is substituted for Node_Ind, the node index value in Equation 7 described above, and thus the position of the control word in which the measurement value of the another node is stored can be specified. It is noted that, based on the setting information that is received from the radio equipment controller 2 in the sequence for the initialization with the radio equipment controller 2, the number of radio equipment 3 (the number of nodes) in the link structure in which the multistage connections to a plurality of radio equipment 3 are made is assumed to be set when it comes to the radio equipment 3. In the manner as described above, the setting information can be transmitted from the radio equipment controller 2 to each of radio equipment 3 using the control word that constitutes the fast C&M.

In a case where a measurement value of another node is stored in the basic frame that is received from the front stage node (YES in S108), the radio equipment 3 stores the measurement value of the another node in the measurement value table T10 (S109). For example, the first extraction unit 311 of the radio equipment 3 inputs a value that is acquired from the control word that is present in a storage position of another node, into the control unit 33. If the value of the another node, which is input from the first extraction unit 311, for example, is a value other than the null value, the control unit 33 into which the value is input determines that the measurement value of the another node is stored in the basic frame that is received from the front stage node (YES in S108), and updates the values in the measurement value table T10 that is stored in the storage unit 34 (S109). It is noted that, in a case where it is determined in Processing S108 that the measurement value of the another node is not stored in the basic frame that is received from the front stage node (NO in S108), Processing S109 may be skipped without being performed.

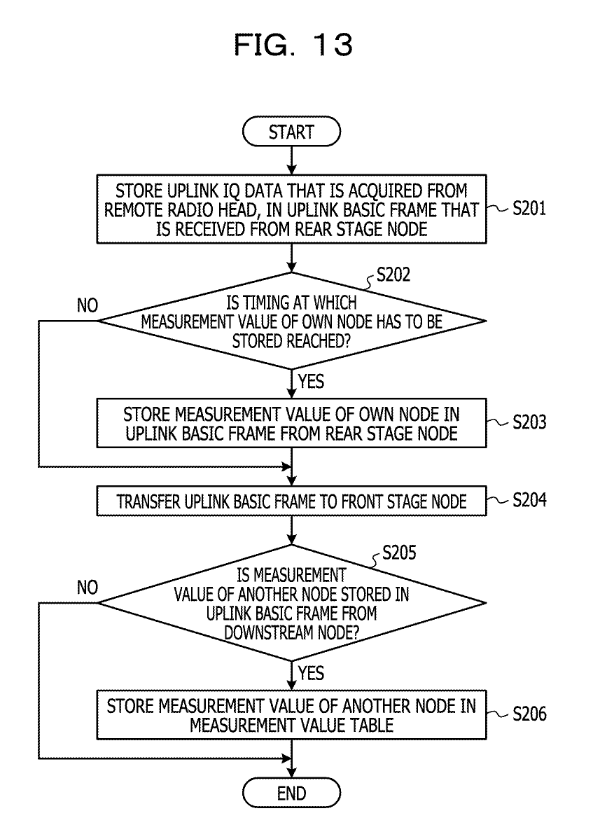

What is described above is an example of the flow of the processing on the downlink basic frame in the radio equipment 3 according to the present embodiment. Next, an example of a flow of processing on an uplink basic frame in the radio equipment 3 according to the present embodiment is described with reference to FIG. 13. The flow of the processing that is illustrated in FIG. 13, for example, may be set to be repeatedly performed at a timing that is synchronized with a periodicity of the uplink basic frame that is transmitted on the CPRI interface, and may be set to start to be performed according to the detection of the reception of the uplink basic frame.

First, the radio equipment 3 stores the IQ data that is received from the remote radio head 35, in the uplink basic frame that is received from the rear stage node (S201). In Processing S201, for example, the second CPRI processing unit 32 of the radio equipment 3 transfers the uplink basic frame that is received from the rear stage node, to the first CPRI processing unit 31. The uplink basic frame is received and the first insertion unit 312 of the radio equipment 3 stores the uplink IQ data, which is acquired from the remote radio head 35 of the own node, in the basic frame that is transferred from the second CPRI processing unit 32. At that time, a position (the division block) on the basic frame in which the IQ data that is acquired from the remote radio head 35 of the own node is stored is specified using the same procedure as in the method of specifying the storage position (the division block) of the IQ data that corresponds to the radio area which is provided by the own node in Processing S101 for the downlink, which is illustrated in FIG. 9. It is noted that, in a case where a value of the IQ data other than the null value is already stored in the division block that is used for the storing of the IQ data of the own node, the IQ data of the own node is stored in the value of IQ data that is already stored, by performing compositing processing, such as adding the value of the IQ data of the own node. That is, the storing of the IQ data of the rear stage node that is already stored in the division block which is used in the own node means that the radio area that is provided by the own node is the shared area.

The radio equipment 3 determines whether or not the basic frame from the rear stage node corresponds to the timing at which the measurement value of the own node has to be stored (S202). For example, in a case where the index value X of the basic frame from the rear stage node is acquired from the second CPRI processing unit 32 and the index value X of the basic frame is consistent with the timing X0 that is allocated to the own node, the control unit 33 of the radio equipment 3 can determine that the basic frame from the rear stage node corresponds to a timing at which the measurement value of the own node has to be stored (YES in S202). In a method of acquiring the timing X0 that is allocated to the own node, in Processing S104 for the downlink, which is illustrated in FIG. 9, the same procedure as in the method of specifying the storage position of the measurement value of the own node in the subchannel structure for control words can be used.

In a case where it is determined that the basic frame from the rear stage node corresponds to the timing at which the measurement value of the own node has to be stored (YES in S202), the radio equipment 3 stores the measurement value relating to the uplink traffic situation that is measured in the own node, in the uplink basic frame from the rear stage node (S203) and transfers the basic frame to the front stage node (S204). For example, in a case where it is determined that the basic frame from the rear stage node corresponds to the timing at which the measurement value of the own node has to be stored (YES in S202), the control unit 33 of the radio equipment 3 may acquire the measurement value relating to the traffic situation of the own node, from the measurement unit 36, and may notify the first insertion unit 312 of the first CPRI processing unit 31 of the measurement value of the own node. Accordingly, the first CPRI processing unit 31 can store the measurement value of the own node, in the control word on the basic frame that is received by the second CPRI processing unit 32 from the rear stage node, and can transfer the basic frame to the front stage node. As a modification example, in Processing S202, for example, the control unit 33 may set the index value X0 that indicates the timing at which the measurement value of the own node, which is specified using the method that is described with reference to Equations 5 to 7, has to be stored, and the measurement value relating to the traffic situation of the own node, to be in an internal register of the first CPRI processing unit 31. In this case, the first CPRI processing unit 31 compares the index value X0 that is set to be in the internal register and the index value X of the basic frame from the rear stage node, and in a case where X=X0, can determine that the basic frame from the rear stage node corresponds to the timing at which the measurement value of the own node has to be stored (YES in S202). Furthermore, the first CPRI processing unit 31 can store the measurement value relating to the traffic situation of the own node, which is set to be in the internal register, in the control word of the basic frame (S203), and can transfer the basic frame to the front stage node (S204).

On the other hand, in Processing S202, for example, in a case where it is determined that the basic frame from the rear stage node does not correspond to the timing at which the measurement value of the own node has to be stored (NO in S202), the control unit 33 of the radio equipment 3 may not notify the first insertion unit 312 of the first CPRI processing unit 31 of the measurement value of the own node. Accordingly, the first CPRI processing unit 31 skips Processing S203 without performing Processing S203, and transfers the basic frame that is received by the second CPRI processing unit 32 from the rear stage node, to the front stage node (S204).

The radio equipment 3 determines whether or not a measurement value of another node is stored in the uplink basic frame from the rear stage node (S205). For example, the second extraction unit 322 of the radio equipment 3 can specify a position of the control word in which a measurement value of another node is stored, with the same procedure in the method of specifying the position of the control word in which the measurement value of the own node is stored. For example, an index value of another node is substituted for Node_Ind, the node index value in Equation 7 described above, and thus the position of the control word in which the measurement value of the another node is stored can be specified. That is, the number of radio equipment 3 (the number of nodes) in the link structure in which the multistage connections to a plurality of radio equipment 3 are made is set to N, for example, positive integers in {0, . . . , N-1} are sequentially substituted for Node_Ind, and thus the position of the control word in which a measurement value of another node is stored can be specified. It is noted that, based on the setting information that is received from the radio equipment controller 2 in the sequence for the initialization with the radio equipment controller 2, the number of radio equipment 3 (the number of nodes) in the link structure in which the multistage connections to a plurality of radio equipment 3 are made is assumed to be set when it comes to the radio equipment 3. In the manner as described above, the setting information can be transmitted from the radio equipment controller 2 to each of radio equipment 3 using the control word that constitutes the fast C&M.

In a case where a measurement value of another node is stored in the basic frame that is received from the rear stage node (YES in S205), the radio equipment 3 stores the measurement value of the another node in the measurement value table T10 (S206). For example, the second extraction unit 322 of the radio equipment 3 inputs a value that is acquired from the control word that is present in a storage position of another node, into the control unit 33. If the value of the another node, which is input from the second extraction unit 322, for example, is a value other than the null value, the control unit 33 into which the value is input determines that the measurement value of the another node is stored in the basic frame that is received from the rear stage node (YES in S205), and updates the values in the measurement value table T10 that is stored in the storage unit 34 (S206). It is noted that, in a case where it is determined in Processing S205 that the measurement value of the another node is not stored in the basic frame that is received from the rear stage node (NO in S205), Processing S206 may be skipped without being performed.

What is described above is an example of the flow of the processing on the uplink basic frame in the radio equipment 3 according to the present embodiment. The radio equipment 3 performs the processing on the uplink and downlink basic frames, which are described above, and thus can collect the measurement value of the own node and a measurement value of another node, and can update the measurement value of each node in the measurement value table T10.

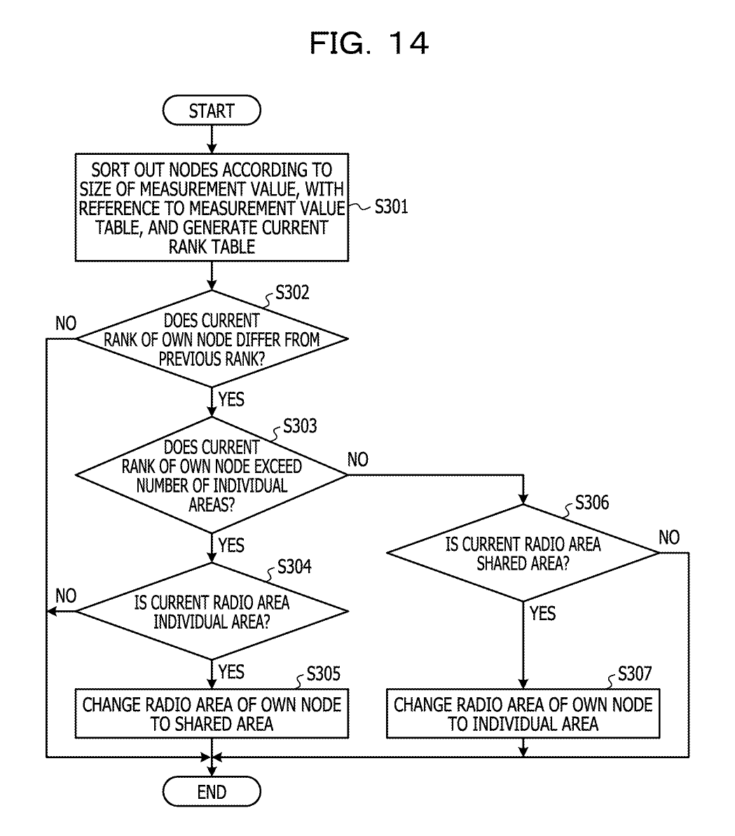

Next, area selection processing that uses the measurement value table T10 is described with reference to FIG. 14. FIG. 14 is a diagram illustrating an example of a flow of the area selection processing in the radio equipment 3 according to the present embodiment. The flow of the processing that is illustrated in FIG. 14, for example, may be performed with an arbitrary periodicity. For example, the flow of the processing may start to be performed at a timing (for example, with a periodicity of 10 ms) that is synchronized with a downlink or uplink radio frame.

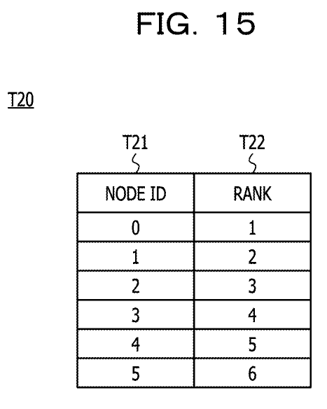

First, the radio equipment 3 sorts out nodes (a plurality of radio equipment 3 in the link structure) according to a size of the measurement value, withe reference to the measurement value table T10, and creates a current rank table T20 (S301). For example, with reference to the measurement value table T10 that is stored in the storage unit 34, the control unit 33 of the radio equipment 3 allocates rank N in decreasing order of the measurement value of the node, starting from rank 1. At this point, N is a value that indicates the number of radio equipment 3 (the number of nodes) in the link structure in which the multistage connections to a plurality of radio equipment 3 are made. FIG. 15 is a diagram illustrating an example of contents of the rank table T20 that is used for description of the radio equipment according to the present embodiment. The rank table T20 that is illustrated in FIG. 15 has an information structure in which the node ID (T21) for identifying each of radio equipment 3 and a rank (T22) that is allocated according to the measurement value of each node are associated with each other. In an example of the rank table T20 that is illustrated in FIG. 15, for the node ID (T21), the node index value indicating the position of each of radio equipment 3 in the link structure in which the multistage connections are made is used. For example, node #0 indicates the radio equipment 3A in the example that is illustrated in FIG. 1, node #1 indicates the radio equipment 3B, node #2 indicates the radio equipment 3C, node #3 indicates the radio equipment 3D, node #4 indicates the radio equipment 3E, and node #5 indicates the radio equipment 3F. In an example in FIG. 15, it is illustrated that measurement value #A of node #0 (that is, the radio equipment 3A) is the greatest, and rank “1” is allocated. On the other hand, it is illustrated that measurement value #F of node #5 (that is, the radio equipment 3F) is the smallest and rank “6” is allocated. It is noted that it is assumed that the storage unit 34 can retain the rank tables T20 at least at two points in time, that is, a past rank table and a current rank table. In Processing S301, in a case where a plurality of nodes have the same size of the measurement value, for example, the rank may be decided in increasing order of the node ID.

Next, the radio equipment 3 determines whether or not a rank (a current rank) of the own node, which is illustrated in the rank table T20 that is currently generated, differs from a rank (the previous rank) of the own node, which is illustrated in the rank table T20 that is previously generated (S302). At this point, when the processing that is illustrated in FIG. 14 is initially performed, for example, in all nodes, an initial value “0” is assumed to be set for the previous rank that is retained in the storage unit 34. When Processing S302 is initially performed, for example, the control unit 33 of the radio equipment 3 compares a current rank of the own node, which is illustrated in the rank table T20 that is an example of contents which are illustrated in FIG. 15, and a previous rank (for example, 0) of the own node, which is illustrated in the rank table T20 that is one past rank table in which initial values are set, and determines that the current rank of the own node differs from the previous rank (YES in S302). It is noted that, in a case where it is determined in Processing S302 that the current rank and the previous rank are the same (NO in S302), the control unit 33 of the radio equipment 3 may skip Processing S303 to Processing S307 that follow, without performing Processing S303 to Processing S307.

In a case where it is determined in Processing S302 that the current rank of the own node differs from the previous rank (YES in S302), the control unit 33 of the radio equipment 3 determines whether or not the current rank of the own node exceeds the number of individual areas (S303). At this point, the individual area is a radio area that is provided by one certain radio equipment 3, and refers to a radio area that is not shared among a plurality of radio equipment 3. As another type of radio area, there is a shared area. The shared area refers to a radio area that is provided by two or more of radio equipment 3. The total number of individual areas and shared areas is set to a value that is smaller than the number of nodes. In the description of the present embodiment, as an example, while the number of nodes is 6, the number of individual areas is 3, the number of shared areas is 1, and the total number of individual areas and shared areas is 4. That is, the total number of individual areas and shared areas is equivalent to the number of division blocks in a basic frame structure on the CPRI interface. In the example of the structure of the basic frame in FIG. 7, the number of division blocks is “4”. In other words, in the example of the structure of the basic frame that is illustrated in FIG. 7, the IQ data of the individual area can be stored in three blocks that are division blocks (F25 to F27), and the IQ data of the shared area is stored in one block that is the division block (F28).

The control unit 33 of the radio equipment 3 compares the current rank of the own node and the number of individual areas, and determines, and, in a case where it is determined that the current rank of the own node exceeds the number of individual areas (YES in S303), changes the radio area that is provided by the own node, to the shared area (S305), if the current radio area that is provided by the own node is the individual area (YES in S304). That is, in this case, the measurement value relating to the traffic situation of the own node indicates a relatively low value, and there is a likelihood that the radio resource will not be sufficiently utilized although the own node provides the individual area. Because of this, an action is taken in which great importance is placed on contribution to a reduction in the transmission rate of the CPRI interface by the selection of the shared area. In Processing S305, for example, the control unit 33 of the radio equipment 3 may set an area value of the division block that corresponds to a post-change area which is specified using the method that is described with reference to Equations 1 to 4, to be in internal registers of the first CPRI processing unit 31 and the second CPRI processing unit 32. In this case, based on the index value of the division block that corresponds to the post-change area that is set by the control unit 33, the first CPRI processing unit 31 and the second CPRI processing unit 32 can smoothly perform processing that extracts and inserts the IQ data that comes from the basic frame. Alternatively, the control unit 33 may set the index value of the division block that corresponds to the post-change area, to be in the internal registers of the first CPRI processing unit 31 and the second CPRI processing unit 32. In this case, based on the area value of the division block that corresponds to the post-change area that is set by the control unit 33, the first CPRI processing unit 31 and the second CPRI processing unit 32 can specify the area value of the division block using the method that is described with reference to Equations 1 to 4, and can smoothly perform the processing that extracts and inserts the IQ data that comes from the basic frame. It is noted that, in a case where all current radio areas that are provided by the own node are shared areas (NO in S304), the control unit 33 of the radio equipment 3, as illustrated in FIG. 14, may skip Processing S305, without performing Processing S305.

On the other hand, in a case where it is determined in Processing S303 that the current rank of the own node does not exceed the number of individual areas (NO in S303), if the current radio area that is provided by the own node is a shared area (YES in S306), the control unit 33 of the radio equipment 3 changes the radio area that is provided by the own node, to the individual area (S307). That is, in this case, the measurement value relating to the traffic situation of the own node indicates a relatively high value and there is a likelihood that the radio resource will be used up when the shared areas are selected as the radio area that is provided by the own node. Because of this, an action is taken in which great importance is placed on securing of the radio resource through the selection of the individual area. In Processing S307, for example, the control unit 33 of the radio equipment 3 may set the area value of the division block that corresponds to the post-change area which is specified using the method that is described with reference to Equations 1 to 4, to be in the internal registers of the first CPRI processing unit 31 and the second CPRI processing unit 32. In this case, based on the index value of the division block that corresponds to the post-change area that is set by the control unit 33, the first CPRI processing unit 31 and the second CPRI processing unit 32 can smoothly perform the processing that extracts and inserts the IQ data that comes from the basic frame. Alternatively, the control unit 33 may set the index value of the division block that corresponds to the post-change area, to be in the internal registers of the first CPRI processing unit 31 and the second CPRI processing unit 32. In this case, based on the area value of the division block that corresponds to the post-change area that is set by the control unit 33, the first CPRI processing unit 31 and the second CPRI processing unit 32 can specify the area value of the division block using the method that is described with reference to Equations 1 to 4, and can smoothly perform the processing that extracts and inserts the IQ data that comes from the basic frame. It is noted that, in a case where all current radio areas that are provided by the own node are individual areas (NO in S306), the control unit 33 of the radio equipment 3, as illustrated in FIG. 14, may skip Processing S307, without performing Processing S307.

What is described above is an example of the flow of the area selection processing in the radio equipment 3 according to the present embodiment. Next, an outline of the area selection processing described above is described with reference to examples that are illustrated in FIG. 15 to FIG. 18. It is noted that the number of individual areas in the description of the present embodiment is “3” as an example. In an example of contents of the rank table (T20) that is illustrated in FIG. 15, node #0, node #1, and node #2 are ranks “1”, “2”, and “3”, respectively, and the number of individual areas is not greater than 3. Because of this, the individual area is selected. For example, individual area #1, individual area #2, and individual area #3 are selected in order of rank from highest to lowest. In other words, in the example of the structure of the basic frame that is illustrated in FIG. 7, node #0 whose rank is “1” is selected by division block #1 (F25), node #1 whose rank is “2” is selected by division block #2 (F26), and node #2 whose rank is “3” is selected by division block #3 (F27). On the other hand, node #3, node #4, and node #5 are rank “4”, “5”, and “6”, respectively, and the number of individual areas is greater than “3”. Because of this, the shared area is selected. That is, in the example of the structure of the basic frame that is illustrated in FIG. 7, all of node #3 whose rank is “4”, node #4 whose rank is “5”, and node #5 whose rank “6” select division block #4 (F28).

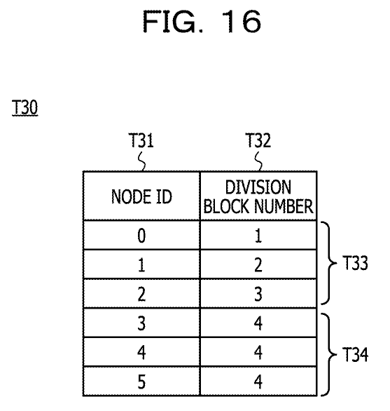

FIG. 16 is a diagram illustrating an example of a detail of a result of the area selection that is used for the description of the radio equipment according to the first embodiment. In an example in FIG. 16, the result of the area selection in each node, which is described above, is illustrated in a tabular form (T30) for a node ID (T31) and a division block number (T32). In the example in FIG. 16, it is illustrated that node #0 to node #2 select division block numbers, “1”, “2”, and “3”, respectively, as individual areas (T33). Furthermore, in the example in FIG. 16, it is illustrated that node #3 and node #5 select division block number “4”, as a shared area (T34). It is noted that the radio equipment 3 is not limited to storing all contents of a selection result table T30 that is illustrated in FIG. 16 in the storage unit 34. Each of radio equipment 3 may store at least a result of selection by the own node in the storage unit 34.

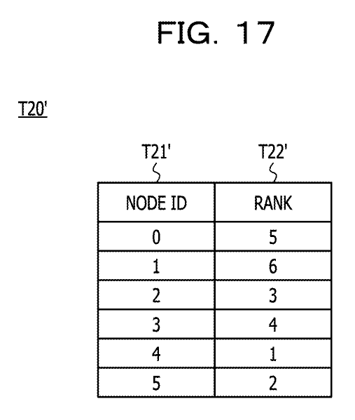

Next, it is assumed that a result of updating the contents of the measurement value table T10, and the contents of the rank table are changed from the example (the rank table T20) that is illustrated in FIG. 15 to an example (a rank table T20′) that is illustrated in FIG. 17. That is, in this case, ranks that are illustrated in FIG. 15 are previous ranks, and ranks that are illustrated in FIG. 17 are current ranks. In the example that is illustrated in FIG. 17, ranks of node #0 and node #1 are changed to ranks “5” and “6”, respectively, which are low ranks. On the other hand, ranks of node #4 and node #5 are changed to ranks “1” and “2”, respectively, which are high ranks. It is noted that ranks of node #2 and node #3 are ranks “3” and “4”, respectively, which are the same as the previous ranks.

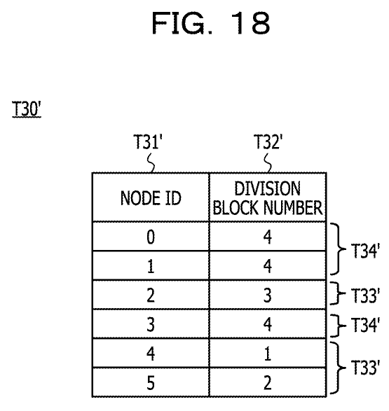

FIG. 18 is a diagram illustrating a result of (T30′) of the area selection in each node, based on the example of contents that are illustrated in FIG. 17. In the example that is illustrated in FIG. 18, it is illustrated that because the current ranks of node #0 and node #1 are greater than the number of individual areas, node #0 and node #1 select division block number “4”, as a shared area (T34′). That is, node #0 and node #1 change their respective areas from the individual areas (T33) to the shared area (T34′). On the other hand, because current ranks of node #4 and node #5 are not greater than the number of individual areas, node #4 and node #5 select division blocks “1” and “2”, respectively, as individual areas (T33′). That is, node #4 and node #5 change their respective areas from the shared areas (T34) to the individual area (T33′). It is noted that because current ranks of node #2 and node # are the same as the previous ranks, respectively, node #2 and node #3 continue to select the same division blocks as the division blocks that are previously selected, respectively.

What is described above is an outline of the area selection processing in the radio equipment 3 according to the present embodiment. With the processing described above, a radio area (a shared area) that is shared among one or several items of radio equipment 3 that are among a plurality of radio equipment 3, can be provided, and one or several radio equipment 3, among the other radio equipment 3, can provide individual radio areas (individual areas), respectively. Accordingly, an amount of IQ data that is transmitted on the CPRI interface between the radio equipment controller 2 and the radio equipment 3 can be reduced, compared with a case where each of the plurality of radio equipment 3 evenly provides an individual radio area (an individual area), and as a result, the transmission rate of the CPRI interface can be reduced. Furthermore, each node compares the measurement value relating to the traffic situation that is measured in the own node, and the measurement value that is collected from another node, and thus can autonomously select whether the radio area that is provided by the own node has to be set to be a shared area or an individual area. For this reason, a computing load that is desirable for the processing that determines a type of radio area which has to be provided by each node does not have to be imposed on the radio equipment controller 2.

### Second Embodiment

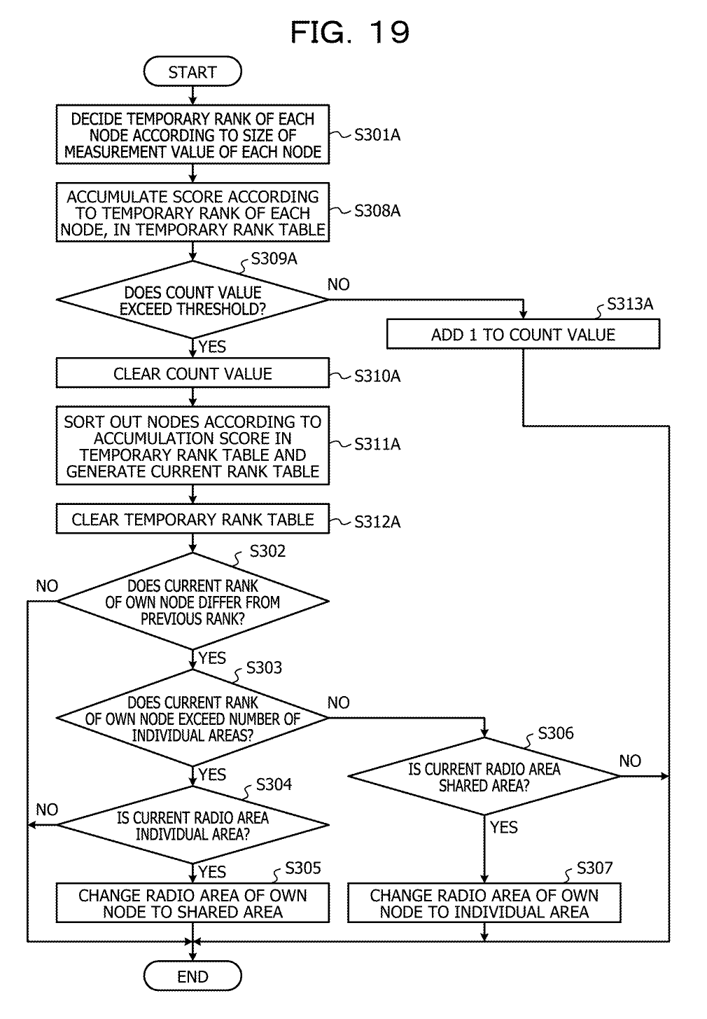

Next, a second embodiment of area selection processing is described with reference to FIG. 19. FIG. 19 is a diagram illustrating an example of a flow of the area selection processing in radio equipment according to the second embodiment. In an example in FIG. 19, the same processing as in the flow of the area selection processing according to the first embodiment, which is illustrated in FIG. 14 is given the same reference numeral. That is, in FIG. 19, Processing S302 to Processing S307 are the same as in the flow of the processing that is illustrated in FIG. 14. In an example of the flow of processing that is illustrated in FIG. 19, as in the example that is illustrated in FIG. 14, for example, the flow of the processing may start to be performed at a timing (for example, with a periodicity of 10 ms) that is synchronized with the downlink or uplink radio frame.

The flow of the area selection processing according to the second embodiment, which is illustrated illustrate FIG. 19 differs from that according to the first embodiment, which is illustrated in FIG. 14, in that results of performing the area selection processing a plurality of times are accumulated without the area being changed only with a result of performing one-time area selection processing.

First, with reference to the measurement value table T10, the radio equipment 3 sorts out nodes according to the size of the measurement value, and decides a temporary rank of each node according to the size of the measurement value of each node (S301A). For example, with reference to the measurement value table T10 that is stored in the storage unit 34, the control unit 33 of the radio equipment 3 allocates a temporary rank N that starts from a temporary rank 1, in decreasing order of the measurement value. At this point, N is a value that indicates the number of radio equipment 3 (the number of nodes) in the link structure in which the multistage connections to a plurality of radio equipment 3 are made. In Processing S301A, in the case where a plurality of nodes have the same size of the measurement value, for example, the temporary rank may be decided in increasing order of the node ID.

Next, the radio equipment 3 accumulates a score in accordance with the temporary rank of each node, in a temporary rank table (S308A). For example, the control unit 33 of the radio equipment 3 adds a value of the temporary rank to a value in the temporary rank table that is stored in the storage unit 34. That is, if the temporary rank is “1”, “1” is added to the value in the temporary rank table. If the temporary rank is “2”, “2” is added to the value in the temporary rank table. It is noted that an initial value in the temporary rank table, for example, is a zero value.

The radio equipment 3 determines whether or not the number of times (a count value) that the area selection processing which is illustrated in FIG. 19 is performed reaches a predetermined value (a threshold) (S309A). It is noted that it is assumed that an initial value of the number of times that the area selection processing is performed, for example, is a zero value, and is stored, as a count value, in the storage unit 34. For example, in a case where it is determined that the count value does not exceed the threshold (NO in S309A), the control unit 33 of the radio equipment 3 adds 1 to the count value that is stored in the storage unit 34, for update (S313), and ends the processing in FIG. 19 until a next timing for performance comes.

In a case where it is determined that the count value exceeds the threshold (YES in S309A), the radio equipment 3 clears the count value, for example, to a zero value (S310A), sorts out nodes according to an accumulation score in the temporary rank table, and creates a current rank table T20 (S311A). For example, with reference to the accumulation score of the temporary rank table that is stored in the storage unit 34, the control unit 33 of the radio equipment 3 allocates a rank 1 to a rank N to nodes starting from a node that has the lowest accumulation score, and stores a current rank table T20 in the storage unit 34. At this point, N is a value that indicates the number of radio equipment 3 (the number of nodes) in the link structure in which the multistage connections to a plurality of radio equipment 3 are made. In a case where the value of the temporary rank is accumulated in the temporary rank table in Processing S308A, the fact that the accumulation score in the temporary rank table is low means that the accumulated temporary rank is a high rank. For example, when, in performing Processing S308A, a value 1 of the highest rank is accumulated 10 times (that is, threshold of Processing S309A=8), the accumulation score is “10”. On the other hand, when, in performing Processing S308A, a value “N” of the lowest rank is accumulated 10 times, the accumulation score is “10×N” (in a case where N=6, the accumulation score is “60”). It is noted that it is assumed that the storage unit 34 can retain the rank tables T20 at least at two points in time, that is, a past rank table and a current rank table. In Processing S311A, in a case where a plurality of nodes have the same size of the accumulation score, for example, the rank may be decided in increasing order of the node ID.

Next, the radio equipment 3 clears the temporary rank table, for example, to a zero value (S312A), and determines whether or not a rank (a current rank) of the own node, which is illustrated in the rank table T20 that is currently generated, differs from a rank (the previous rank) of the own node, which is illustrated in the rank table T20 that is previously generated (S302). Because Processing S302 to Processing S307 that follow are the same as the area selection processing according to the first embodiment, which is illustrated in FIG. 14, descriptions thereof are omitted.

With the area selection processing according to the second embodiment, which is described above, because the results of performing the area selection processing a plurality of times are accumulated and the rank of the node is decided according to the result of the accumulation, the area can be suppressed from being frequently changed due to a temporary change in the rank.

### Third Embodiment

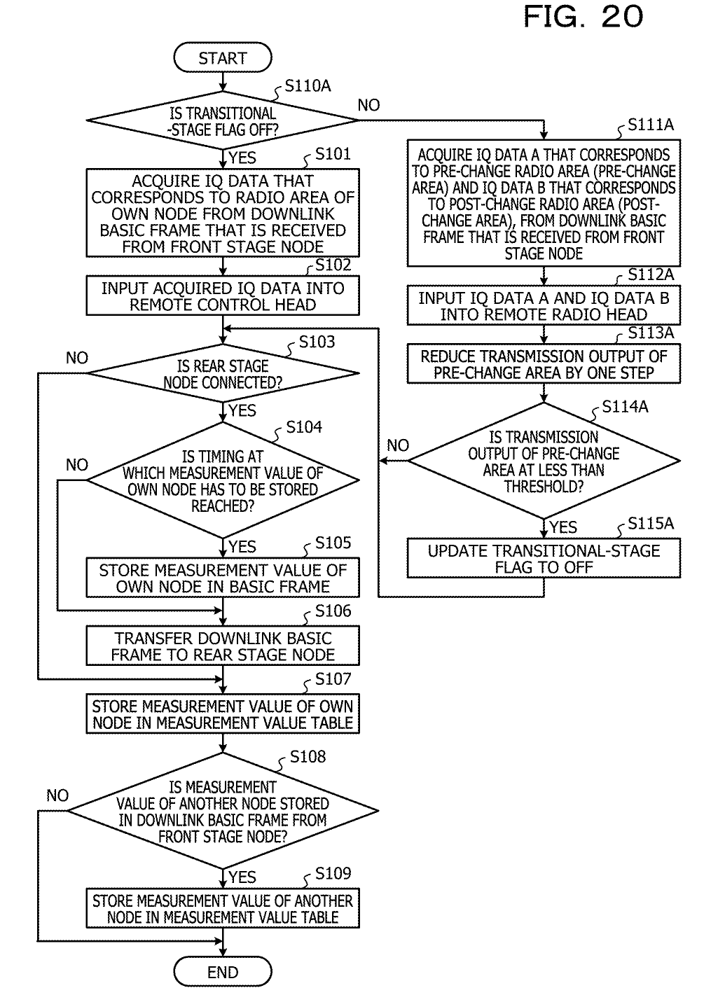

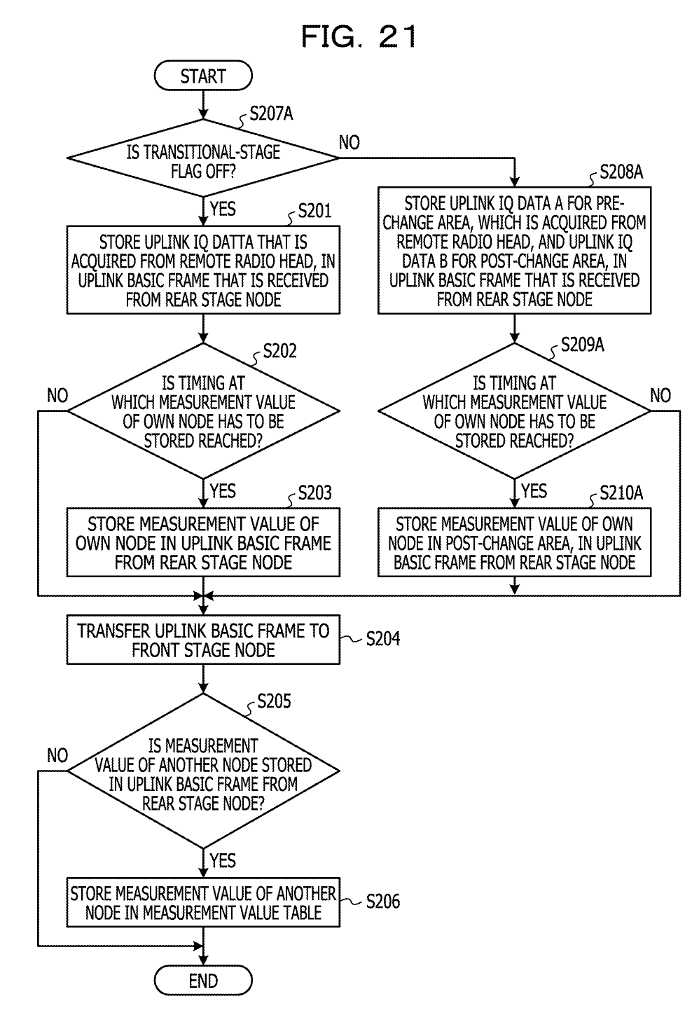

Next, an example of a flow of processing on a basic frame in radio equipment 3 according to a third embodiment is described with reference to FIG. 20 and FIG. 21. FIG. 20 is a diagram illustrating an example of a flow of processing on a downlink basic frame in the radio equipment according to the third embodiment. The flow of the processing that is illustrated in FIG. 20 and FIG. 21, for example, may be set to be repeatedly performed at a timing that is synchronized with a periodicity of the basic frame that is transmitted on the CPRI interface, and may be set to start to be performed according to the detection of the reception of the basic frame from the front stage node or the rear stage node.

An example of the flow of the processing on the downlink basic frame that is illustrated in FIG. 20 differs from that according to the first embodiment that is illustrated in FIG. 9 in that, in a case where a type of radio area is changed in the area selection processing, the radio area is provided using the IQ data for two areas before and after the change during a predetermined period of time.

First, the radio equipment 3 determines whether or not a transitional-stage flag is off (S110A). For example, in Processing S110A, the first CPRI processing unit 31 of the radio equipment 3 may determine whether or not the transitional-stage flag is off, with reference to a value of the transitional-stage flag that is stored in the internal register within the first CPRI processing unit 31. At this point, the transitional-stage flag is a flag indicating that it is determined that a type of radio area that is provided by the own node is changed, in the area selection processing that is illustrated in FIG. 14 or FIG. 19. For example, in Processing S305 and Processing S307 that are illustrated in FIG. 14 or FIG. 19, the control unit 33 of the radio equipment 3 sets the transitional-stage flag to be off. It is noted that the transitional-stage flag may be stored not only in the internal register of the first CPRI processing unit 31, but also in the internal register of the second CPRI processing unit 32 and in the storage unit 34.

In a case where the transitional-stage flag is off (YES in S110A), the first CPRI processing unit 31 of the radio equipment 3 acquires the IQ data that corresponds to the radio area which is provided by the own node, from the downlink basic frame that is received from the front stage node (S101). Because processing S101 to Processing S109 that follow are the same as in the first embodiment that is illustrated in FIG. 9, descriptions thereof are omitted.

On the other hand, in a case where the transitional-stage flag is on (NO in S110A), the first CPRI processing unit 31 of the radio equipment 3 acquires IQ data A from the division block that corresponds to a type of pre-change radio area (pre-change area), and IQ data B from the division block that corresponds to a type of post-change radio area (post-change area), from the downlink basic frame that is received from the front stage node (S111A), and inputs the acquired IQ data A and IQ data B into the remote radio head 35 (S112A).

In a case where the transitional-stage flag is on, the radio equipment 3 reduces a transmission output for the pre-change area by one step (S113A). For example, the control unit 33 of the radio equipment 3 may input a control signal into the transmission amplifier 352 of the remote radio head 35 in such a manner that the transmission output for the pre-change area is reduced to an output at a predetermined level. Whenever the processing that is illustrated in FIG. 20 is repeatedly performed, the transmission output for the pre-change area is reduced, and thus the UE that serves the pre-change area is caused to transition to the post-change area.

The radio equipment 3 determines whether or not the transmission output for the pre-change area is at less than a threshold (S114A). For example, in Processing S114A, the control unit 33 of the radio equipment 3 may determine whether or not a setting value of a current transmission output for the pre-change area that is stored in the storage unit 34 is less than the threshold.

In a case where the transmission output for the pre-change area is at less than the threshold (YES in S114A), the radio equipment 3 updates the transitional-stage flag in such a manner that the transitional-stage flag is on (S115A). For example, in Processing S115A, the control unit 33 of the radio equipment 3 may set the transitional-stage flag, which is stored in the internal register of the first CPRI processing unit 31, to be off. In Processing S115A, the control unit 33 of the radio equipment 3 may store the transitional-stage flag that is set to be off, in the internal register of the second CPRI processing unit 32 or in the storage unit 34. At this point, when it comes to the threshold against which the transmission output for the pre-change area is compared, in a case where the transmission output for the pre-change area is at less than the threshold, the threshold may be set to be at such a transmission output level that the UE which serves the pre-change area transitions reliably to the post-change area.

After the transitional-stage flag is updated in Processing S115A in such a manner that the transitional-stage flag is off, or in a case where it is determined in Processing S114A that the transmission output for the pre-change area is not at less than the threshold (NO in S114A), the radio equipment 3 performs Processing S103 and subsequent processing.

What is described above is an example of the flow of the processing on the downlink basic frame in the radio equipment according to the third embodiment. Next, an example of a flow of processing on an uplink basic frame in the radio equipment according to the third embodiment is described with reference to FIG. 21. FIG. 21 is a diagram illustrating the example of the flow of the processing on the uplink basic frame in the radio equipment according to the third embodiment. The example of the flow of the processing on the uplink basic frame that is illustrated in FIG. 21 differs from that according to the first embodiment that is illustrated in FIG. 13 in that, in the case where a type of radio area is changed in the area selection processing, the IQ data for two areas before and after the change during a predetermined period of time is stored in the uplink basic frame.

First, in the same manner in the processing of the downlink basic frame, the radio equipment 3 determines whether or not the transitional-stage flag is off (S207A). For example, in Processing S207A, the first CPRI processing unit 31 of the radio equipment 3 may determine whether or not the transitional-stage flag is off, with reference to the value of the transitional-stage flag that is stored in the internal register within the first CPRI processing unit 31. At this point, in the same manner in the processing of the downlink basic frame, the transitional-stage flag is a flag indicating that it is determined that a type of radio area that is provided by the own node is changed, in the area selection processing that is illustrated in FIG. 14 or FIG. 19. For example, in Processing S305 and Processing S307 that are illustrated in FIG. 14 or FIG. 19, the control unit 33 of the radio equipment 3 sets the transitional-stage flag to be off.

In the case where the transitional-stage flag is off (YES in S207A), the first CPRI processing unit 31 of the radio equipment 3 stores the uplink IQ data, which acquired from the remote radio head 35, in the uplink basic frame that is received by the second CPRI processing unit 32 from the rear stage node (S201). Because Processing S201 to Processing S206 that follow are the same as in the first embodiment that is illustrated in FIG. 13, descriptions thereof are omitted.

On the other hand, in a case where the transitional-stage flag is on (NO in S207A), the first CPRI processing unit 31 of the radio equipment 3 acquires uplink IQ data A for the pre-change area and uplink IQ data B for the post-change area, from the remote radio head 35, and stores the acquired IQ data A and IQ data B in the basic frame that is received by the second CPRI processing unit 32 from the rear stage node (S208A). In Processing S208A, the IQ data A for the pre-change area is stored in the division block that corresponds to the pre-change area, and the IQ data B for the post-change area is stored in the division block that corresponds to the post-change area. It is noted that, in the case where a value of the IQ data other than the null value is already stored in the division block, in the same manner as in the first embodiment, the IQ data of the own node is stored in the value of IQ data that is already stored, by performing the compositing processing, such as adding the value of the IQ data of the own node.

In the same manner as in the first embodiment, the radio equipment 3 determines whether or not the basic frame from the rear stage node corresponds to the timing at which the measurement value of the own node has to be stored (S209A). For example, in the case where the index value X of the basic frame from the rear stage node is acquired from the second CPRI processing unit 32 and the index value X of the basic frame is consistent with the timing X0 that is allocated to the own node, the control unit 33 of the radio equipment 3 can determine that the basic frame from the rear stage node corresponds to the timing at which the measurement value of the own node has to be stored (YES in S209). A more detailed description, which is the same as in the first embodiment, is omitted.

In a case where it is determined that the basic frame from the rear stage node corresponds to the timing at which the measurement value of the own node has to be stored (YES S209A), the radio equipment 3 stores the measurement value relating to the uplink traffic situation in the post-change area, which is measured in the own node, in the uplink basic frame from the rear stage node (S210A), and transfers the basic frame to the front stage node (S204). Because Processing S204 to Processing S206 that follow are the same as in the first embodiment, descriptions thereof are omitted. It is noted that at suitable timing in Processing S115A, the transitional-stage flag in FIG. 21 can be set to be off in Processing S115A that is illustrated in FIG. 20.

With the processing on the basic frame by the radio equipment 3 according to the third embodiment, which is described above, when a type of area is changed, because the radio area is provided using the IQ data before and after the change, the UE that serves the pre-change area can be caused to transition smoothly to the post-change area. For example, by decreasing a transmission output level for the pre-change area, the UE that serves the pre-change area can be caused to perform handover to or cell reselection of the post-change area. Accordingly, the smooth transition of the UE to the post-change area can be realized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station system comprising: a link structure in which a plurality of radio apparatuses are multistage-connected to each other and are configured to communicate with a radio equipment controller,
wherein a downlink transmission frame and an uplink transmission frame between the radio apparatuses and the radio equipment controller include a plurality of blocks, in each of which a data signal is stored,
wherein one or several blocks among the plurality of blocks are allocated to a shared area for a data signal that is shared among two or more of the radio apparatuses, and other blocks are allocated to an individual area for a data signal that is not shared among two or more of the radio apparatuses,
wherein each of the radio apparatuses is configured to
execute a transferring process that includes transferring a measurement value relating to a traffic situation of an own radio apparatus, the measurement value being stored in at least one of the downlink transmision frame that is transferred from a front stage radio apparatus to a rear stage radio apparatus and the uplink transmision frame that is transferred from the rear stage radio apparatus to the front stage radio apparatus in the link structure, the front stage radio appratus being one of the radio apparatuses and being located at start of the link structure, the rear stage radio apparatus being one of the radio apparatuses and being located at end of the link structure,
execute a collecting process that includes collecting a measurement value relating to a traffic situation of each of other radio apparatuses using at least one of the uplink transmission frame and the downlink transmission frame, and
execute a selecting process that includes selecting whether the block that is used for a radio area which is provided by the own radio equipment is set to be a block that is allocated to the shared area, or a block that is allocated to the individual area, based on the collected measurement value relating to the traffic situation of each of the other radio apparatuses and the measurement value relating to the traffic situation of the own radio apparatus.

2. The base station system according to claim 1,
wherein the measurement value relating to the traffic situation is a value corresponding to a signal strength of an uplink signal that is received with an antenna of the own radio apparatus.

3. The base station system according to claim 2,
wherein the transmission frame is a basic frame on a common public radio interface (CPRI), and
wherein the radio apparatus stores the measurement value relating to the traffic situation in a given area of a control word included in the basic frame.

4. The base station system according to claim 3,
wherein the selecting process includes:
sorting out the own radio apparatus and the other radio apparatuses, according to a size of the collected measurement value relating to the traffic situation of each of the other radio apparatuses and a size of the measurement value relating to the traffic situation of the own radio apparatus,
specifying a rank indicating that where the measurement value relating to the traffic situation of the own radio apparatus ranks in, and
in a case where the rank of the own radio apparatus is a value greater than the number of blocks that are allocated to the individual area, selecting the shared area as the block that is used in the radio area which is provided by the own radio apparatus.

5. The base station system according to claim 4,
wherein the selecting process includes:
sorting out the own radio apparatus and the other radio apparatuses, according to the size of the collected measurement value relating to the traffic situation of each of the other radio apparatuses and the size of the measurement value relating to the traffic situation of the own radio apparatuses,
specifying the rank indicating that where the measurement value relating to the traffic situation of the own radio apparatus ransks in, and
in a case where the rank of the own radio apparatus is a value not greater than the number of blocks that are allocated to the individual area, selecting the individual area as the block that is used in the radio area which is provided by the own radio apparatus.

6. The base station system according to claim 3,
wherein the selecting process includes:
accumulating scores according to sizes of the collected measurement values of the other radio apparatuses and the measurement value of the own radio apparatus in a given period of time,
sorting out the own radio apparatus and the other radio apparatuses based on an accumulated score that results from accumulating the scores,
specifying a rank which the accumulated score of the own radio apparatus indicates that where the measurement value relating to the traffic situation of the own radio apparatus ranks in, with respect to measurement values relating to a plurality of traffic situations within the given period of time, and
in a case where the rank of the own radio apparatus is a value greater than the number of blocks that are allocated to the individual area, selecting the individual area as the block that is used for the radio area which is provided by the own radio apparatus.

7. The base station system according to claim 6,
wherein, in a case where the rank of the own radio apparatus is a value not greater than the number of blocks that are allocated to the individual area, the radio equipment selects the shared area as the block that is used in the radio area which is provided by the own radio equipment.

8. The base station system according to claim 7,
wherein, the control circuitry are further configured to
execute a transition process if it is determined that a type of radio area that is provided by the own radio equipment is changed from the shared area to the individual area or from the individual area to the shared area, the transition process including:
extracting a data signal for a pre-change area and a data signal for a post-change area from the downlink transmission frame;
setting a transition period during which a radio signal that results from multiplexing the extracted data signals for the pre-change and post-change areas is transmitted; and
causing a transmission output level of the data signal for the pre-change area to be decreased relatively to a transmission output level of the data signal for the post-change area during the transition period.

9. A radio apparatus compatible with a link structure in which a plurality of the radio apparatuses are multistage-connected to each other and are configured to communicate with a radio equipment controller, the radio apparatus comprising:
a memory; and
control circuitry coupled to the memory,
wherein a downlink transmission frame and an uplink transmission frame between the radio equipment controller and the plurality of the radio apparatuses include a plurality of blocks, in each of which a data signal is stored,
wherein, among the plurality of blocks, one or several blocks are allocated to a shared area for a data signal that is shared among two or more of the radio apparatuses, and other blocks are allocated to an individual area a data signal that is not shared among two or more of the radio apparatuses,
wherein the control circuitry is configured to
execute a transferring process that includes transferring a measurement value relating to a traffic situation of an own radio apparatus, the measurement value being stored in at least one of the downlink transmission frame that is transferred from a front stage radio apparatus to a rear stage radio apparatus and the uplink transmission frame that is transferred from the rear stage radio apparatus to the front stage radio apparatus in the link structure, the front stage radio appratus being one of the radio apparatuses and being located at start of the link structure, the rear stage radio apparatus being one of the radio apparatuses and being located at end of the link structure,
execute a collecting process that includes collecting a measurement value relating to a traffic situation of each of other radio apparatuses using at least one of the uplink transmission frame and the downlink transmission frame, and
execute a selecting process that includes selecting whether the block that is used for a radio area which is provided by the own radio equipment is set to be a block that is allocated to the shared area, or a block that is allocated to the individual area, based on the collected measurement value relating to the traffic situation of each of the other radio apparatuses, and the measurement value relating to the traffic situation of the own radio apparatus.

10. The radio apparatus according to claim 9,
wherein the selecting process includes:
sorting out the own radio apparatus and the other radio apparatuses, according to a size of the collected measurement value relating to the traffic situation of each of the other radio apparatuses and a size of the measurement value relating to the traffic situation of the own radio apparatus;
specifying a rank indicating that where the measurement value relating to the traffic situation of the own radio apparatus ranks in; and
in a case where the rank of the own radio apparatus is a value greater than the number of blocks that are allocated to the individual area, selecting the shared area as the block that is used in the radio area which is provided by the own radio apparatus.

11. The radio apparatus according to claim 9,
wherein the selecting process includes:
accumulating scores according to sizes of the collected measurement values relating to the traffic situations of the other radio apparatuses and the measurement value relating to the traffic situation of the own radio apparatus in a given period of time;
sorting out the own radio apparatus and the other radio apparatuses based on an accumulated score that results from accumulating the scores;
specifying a rank which the accumulated score of the own radio apparatus indicates that where the measurement value relating to the traffic situation of the own radio apparatus ranks in, with respect to measurement values relating to a plurality of traffic situations within the given period of time; and
in a case where the rank of the own radio apparatus is greater than the number of blocks that are allocated to the individual area, selecting the individual area as the block that is used for the radio area which is provided by the own radio apparatus.

12. The radio apparatus according to claim 11,
wherein, the control circuitry are further configured to
execute a transition process if it is determined that a type of radio area that is provided by the own radio equipment is changed from the shared area to the individual area or from the individual area to the shared area, the transition process including:
extracting a data signal for a pre-change area and a data signal for a post-change area;
setting a transition period during which a radio signal that results from multiplexing the extracted data signals for the pre-change and post-change areas is transmitted; and
causing a transmission output level of the data signal for the pre-change area to be decreased relatively to a transmission output level of the data signal for the post-change area during the transition period.
